(19) United States
(12) Patent Application Publication
(10) Pub. No.: US 2026/0220330 A1
(43) Pub. Date: Jul. 30, 2026

(54) DEVICE ANALYSIS SYSTEM AND METHOD FOR DERIVING PARTIAL ELECTRON DENSITY

(71) Applicant: Korea Advanced Institute of Science and Technology, Daejeon (KR)

(72) Inventors: Yong-Hoon Kim, Daejeon (KR); Ryong Gyu Lee, Daejeon (KR); Hyeonwoo Yeo, Daejeon (KR); Juho Lee, Daejeon (KR)

(21) Appl. No.: 19/455,065

(22) Filed: Jan. 21, 2026

(30) Foreign Application Priority Data
Jan. 24, 2025 (KR) 10-2025-0010924

(51) Int. Cl. G06F 30/23; G06F 111/10

(52) U.S. Cl. CPC G06F 30/23; G06F 2111/10

(57) ABSTRACT

A device analysis system according to an embodiment of the present disclosure includes a controller. The controller is configured to simulate a device including an electrode unit and a channel. The device is in a non-equilibrium state in which a voltage is applied to the electrode unit. The controller is configured to derive a total electron density. The controller is configured to derive a total electron number. The controller is configured to derive a plurality of partial electron numbers. The controller is configured to compare a sum of the plurality of partial electron numbers with the total electron number and derive a plurality of output electrochemical potentials. The controller is configured to derive an occupation probability of each electron state through the plurality of output electrochemical potentials and derive the total electron density through the occupation probability of each electron state.

### CROSS-REFERENCE TO RELATED APPLICATION

This application claims priority to and benefits of Korean Patent Application No. 10-2025-0010924, under 35 U.S.C § 119, filed on Jan. 24, 2025, in the Ministry of Intellectual Property, the contents of which are incorporated herein in its entirety by reference.

### BACKGROUND

### 1. Technical Field

The present disclosure relates to a device analysis system and a method thereof, and more particularly, to a device analysis system and a method thereof in which a device is simulated and non-equilibrium characteristics, partial characteristics, and partial non-equilibrium characteristics of the device are analyzed.

### 2. Description of the Related Art

As one type of device analysis system and device analysis method, electronic design automation (EDA) technologies such as electronic computer-aided design (ECAD) and technology computer-aided design (TCAD) have been provided. The EDA technologies can derive characteristics of a device through a first-principles methodology without manufacturing the device. Accordingly, when the EDA technology is introduced, the manufacturing of a device for verifying device characteristics may be omitted, thereby reducing device design costs.

The first-principles methodology is a simulation method that does not use experimental data or empirical models. Included as examples of device analysis methods using the first-principles methodologies may be density functional theory (DFT) and non-equilibrium Green's function (NEGF) methodologies.

The density functional theory is an analysis method based on a variational principle. Therefore, device analysis using the density functional theory has high reliability and is applied to many research fields. However, while the conventional density functional theory can easily analyze equilibrium systems, it may be difficult to analyze non-equilibrium systems. Meanwhile, in order to analyze characteristics of an operating device, there is a need for a system and method for analyzing a device in a non-equilibrium state.

In addition, as the size of devices is continuously reduced, quantum interactions may occur within the device. Such quantum interactions may make device analysis more difficult. Accordingly, there is a need for a system and method that can separate such interactions and analyze partial characteristics of an entire device.

### SUMMARY

An object of the present disclosure is to provide a device analysis system and a method thereof in which a device is simulated and non-equilibrium characteristics, partial characteristics, and partial non-equilibrium characteristics of the device are analyzed.

A device analysis system according to an embodiment of the present disclosure may include a controller. The controller may be configured to simulate a device including an electrode unit and a channel. The device may be a device in a non-equilibrium state in which a voltage is applied to the electrode unit. The controller may be configured to derive a total electron density defined as a probability density of electrons distributed in the device. The controller may be configured to derive a total number of electrons defined as the number of electrons constituting the device through total electron states corresponding to states of electrons constituting the device. The controller may be configured to derive a plurality of partial electron states corresponding to electrons constituting a part of the device based on a spatial distribution of the total electron states. The controller may be configured to derive a plurality of partial electron numbers, each defined as a number of the electrons constituting a part of the device, through a plurality of input electrochemical potentials and the plurality of partial electron states. The controller may be configured to compare a sum of the plurality of partial electron numbers with the total electron number and derive a plurality of output electrochemical potentials through the plurality of input electrochemical potentials. The controller may be configured to derive an occupation probability of each electron state through the plurality of output electrochemical potentials and derive the total electron density through the occupation probability of each electron state.

In an embodiment of the present disclosure, the electrode unit may include a first electrode and a second electrode, and the channel may be disposed between the first electrode and the second electrode.

In an embodiment of the present disclosure, the plurality of input electrochemical potentials may include an input electrochemical potential of the first electrode and an input electrochemical potential of the second electrode. The plurality of output electrochemical potentials may include an output electrochemical potential of the first electrode and an output electrochemical potential of the second electrode. The controller may be configured to, when a value obtained by subtracting the sum of the plurality of partial electron numbers from the total electron number is greater than a first convergence criterion, derive the output electrochemical potential of the first electrode as a value obtained by adding a potential increment to the input electrochemical potential of the first electrode, and derive the output electrochemical potential of the second electrode as a value obtained by adding the potential increment to the input electrochemical potential of the second electrode, and then substitute the plurality of output electrochemical potentials into the plurality of input electrochemical potentials to reset the plurality of input electrochemical potentials. The controller may be configured to, when the value obtained by subtracting the sum of the plurality of partial electron numbers from the total electron number is less than the first convergence criterion, derive the output electrochemical potential of the first electrode as a value obtained by subtracting a potential decrement from the input electrochemical potential of the first electrode, and derive the output electrochemical potential of the second electrode as a value obtained by subtracting the potential decrement from the input electrochemical potential of the second electrode, and then substitute the plurality of output electrochemical potentials into the plurality of input electrochemical potentials to reset the plurality of input electrochemical potentials. The controller may be configured to re-derive the plurality of partial electron numbers through the reset plurality of input electrochemical potentials. The controller may be configured to, when a difference between the sum of the plurality of partial electron numbers and the total electron number is less than or equal to the first convergence criterion, derive the plurality of output electrochemical potentials to be identical to the plurality of input electrochemical potentials.

In an embodiment of the present disclosure, the controller may be configured to derive an initial electrochemical potential through a voltage applied to the electrode unit. The controller may be configured to set the initial electrochemical potential as the input electrochemical potential. A difference between the initial electrochemical potential of the first electrode and the initial electrochemical potential of the second electrode may be substantially equal to the voltage applied to the electrode unit.

In an embodiment of the present disclosure, the controller may be configured to derive the total electron states through an input total electron density. The controller may be configured to derive an output total electron density through occupation probabilities of the respective electron states. The controller may be configured to, when a difference between a potential of the input total electron density and a potential of the output total electron density exceeds a second convergence criterion, reset the input total electron density as the output total electron density and re-derive the total electron states through the reset input total electron density. The controller may be configured to, when the difference between the potential of the input total electron density and the potential of the output total electron density is less than or equal to the second convergence criterion, derive the total electron density through the output total electron density.

In an embodiment of the present disclosure, the controller may be configured to perform analysis on the device to derive a partial electron density including at least one of an electrode-unit electron density defined as a probability density of electrons distributed in the electrode unit and a channel electron density defined as a probability density of electrons distributed in the channel. The controller may be configured to derive a first potential through an input partial electron density. The controller may be configured to derive a second potential through the input partial electron density and the total electron density. The controller may be configured to derive an output partial electron density through the first potential and the second potential.

In an embodiment of the present disclosure, the controller may be configured to, when a difference between the input partial electron density and the output partial electron density is less than or equal to a third convergence criterion, derive the partial electron density through the output partial electron density. The controller may be configured to, when the difference between the input partial electron density and the output partial electron density exceeds the third convergence criterion, substitute the output partial electron density into the input partial electron density, re-derive the first potential through the input partial electron density, re-derive the second potential through the input partial electron density and the total electron density, and re-derive the output partial electron density through the first potential and the second potential.

In an embodiment of the present disclosure, the first potential may be an effective potential of the input partial electron density according to density functional theory. The second potential may be a value obtained by subtracting a Hartree potential of the input partial electron density from a Hartree potential of the total electron density according to density functional theory.

In an embodiment of the present disclosure, the controller may be configured to derive an initial partial electron density through the total electron density. The controller may be configured to set the initial partial electron density as the input partial electron density.

In another embodiment of the present disclosure, the controller may be configured to derive a plurality of partial electron densities. The controller may be configured to compare the total electron density with a sum of the plurality of partial electron densities. The controller may be configured to, when a difference between the total electron density and the sum of the plurality of partial electron densities is less than or equal to a reliability threshold value, classify the total electron density and the plurality of partial electron densities as high-reliability data.

In another embodiment of the present disclosure, the controller may be configured to, when the difference between the total electron density and the sum of the plurality of partial electron densities exceeds the reliability threshold value, re-derive at least one of the total electron density and the plurality of partial electron densities.

In an embodiment of the present disclosure, the controller may be configured to derive a self-energy matrix of the device through the total electron density. The controller may be configured to derive a Green's function through the self-energy matrix. The controller may be configured to derive a transmission function through the Green's function. The controller may be configured to derive a Landauer formula through the transmission function.

A device analysis method according to an embodiment of the present disclosure may include: performing a total analysis in which a device including an electrode unit having a first electrode and a second electrode and a channel disposed between the first electrode and the second electrode is simulated, wherein the device is a device in a non-equilibrium state in which a voltage is applied to the electrode unit, and analysis is performed on the device to derive a total electron density defined as a probability density of electrons distributed in the device. The step of performing a total analysis may include deriving a total electron number, deriving a partial electron number, re-inputting an electrochemical potential, and outputting a total electron density. In the step of deriving a total electron number, a total number of electrons defined as a number of the electrons constituting the device through total electron states corresponding to states of electrons constituting the device may be derived. In the step of deriving a partial electron number, a plurality of partial electron numbers, each defined as a number of the electrons constituting a part of the device, through a plurality of input electrochemical potentials and a plurality of partial electron states, may be derived. In the step of re-inputting an electrochemical potential, a sum of the plurality of partial electron numbers may be compared with the total electron number, and a plurality of output electrochemical potentials may be derived through the plurality of input electrochemical potentials. In the step of outputting a total electron density, an occupation probability of each electron state may be derived through the plurality of output electrochemical potentials, and an output total electron density may be derived through the occupation probability of each electron state.

In an embodiment of the present disclosure, the plurality of input electrochemical potentials may include an input electrochemical potential of the first electrode and an input electrochemical potential of the second electrode. The plurality of output electrochemical potentials may include an output electrochemical potential of the first electrode and an output electrochemical potential of the second electrode. The step of performing a total analysis may further include a first determination step in which a progression method of the step of re-inputting an electrochemical potential is determined. In the first determination step, when a value obtained by subtracting a sum of the plurality of partial electron numbers from the total electron number is greater than a first convergence criterion, an output electrochemical potential of the first electrode having a value obtained by adding a potential increment to the input electrochemical potential of the first electrode, and an output electrochemical potential of the second electrode having a value obtained by adding the potential increment to the input electrochemical potential of the second electrode, may be derived. In the first determination step, when a value obtained by subtracting the total electron number from the sum of the plurality of partial electron numbers is greater than the first convergence criterion, an output electrochemical potential of the first electrode having a value obtained by subtracting a potential decrement from the input electrochemical potential of the first electrode, and an output electrochemical potential of the second electrode having a value obtained by subtracting the potential decrement from the input electrochemical potential of the second electrode, may be derived. In the first determination step, when a difference between the total electron number and the sum of the plurality of partial electron numbers is less than or equal to the first convergence criterion, the plurality of output electrochemical potentials identical to the plurality of input electrochemical potentials may be derived.

In an embodiment of the present disclosure, the step of performing a total analysis may include an output total electron density deriving step, a total electron density re-inputting step, and a second determination step. In the output total electron density deriving step, an output total electron density may be derived through the plurality of input electrochemical potentials. In the total electron density re-inputting step, the output total electron density may be substituted into an input total electron density. In the second determination step, when a difference between a potential of the input total electron density and a potential of the output total electron density is less than or equal to a second convergence criterion, the step of deriving the total electron density may be performed, and when a difference between the potential of the input total electron density and a potential of the output total electron density exceeds the second convergence criterion, the total electron density re-inputting step may be performed. In the second determination step, when the total electron density re-inputting step is performed, the step of deriving a total electron number, the step of deriving a partial electron number, the first determination step, the step of re-inputting an electrochemical potential, and the output total electron density deriving step may be performed again.

In an embodiment of the present disclosure, the device analysis method may further include a separated analysis step in which the device is simulated and analysis is performed on the device to derive a partial electron density including at least one of an electrode-unit electron density defined as a probability density of electrons distributed in the electrode unit and a channel electron density defined as a probability density of electrons distributed in the channel. The separated analysis step may include a first potential deriving step, a second potential deriving step, and a partial electron density outputting step. In the first potential deriving step, a first potential may be derived through an input partial electron density. In the second potential deriving step, a second potential may be derived through the input partial electron density and the total electron density. In the partial electron density outputting step, an output partial electron density may be derived through the first potential and the second potential.

In an embodiment of the present disclosure, the separated analysis step may further include a partial electron density deriving step, a partial electron density re-inputting step, and a determination step. In the partial electron density deriving step, a partial electron density may be derived through the output partial electron density. In the partial electron density re-inputting step, the output partial electron density may be substituted into the input partial electron density. In the determination step, when a difference between the input partial electron density and the output partial electron density is less than or equal to a third convergence criterion, the partial electron density deriving step may be performed, and when a difference between the input partial electron density and the output partial electron density exceeds the third convergence criterion, the partial electron density re-inputting step may be performed. When the partial electron density re-inputting step is performed, the first potential deriving step, the second potential deriving step, and the partial electron density outputting step may be performed again.

In an embodiment of the present disclosure, in the first potential deriving step, the first potential may be derived as a value obtained by substituting the input partial electron density into a first functional. The first functional may be a functional in density functional theory in which an effective potential is derived by substituting an electron density. In the second potential deriving step, the second potential may be derived as a value obtained by subtracting a value obtained by substituting the input partial electron density into a second functional from a value obtained by substituting the total electron density into the second functional. The second functional may be a functional in density functional theory in which a Hartree potential is derived by substituting an electron density.

In an embodiment of the present disclosure, the separated analysis step may further include a partial electron density inputting step in which the input partial electron density is derived through the total electron density.

In an embodiment of the present disclosure, the device analysis method may further include a current-voltage characteristic deriving step in which a current-voltage characteristic of the device is derived. The current-voltage characteristic deriving step may include a self-energy deriving step, a Green's function deriving step, a transmission function deriving step, and a current-voltage formula deriving step. In the self-energy deriving step, a self-energy matrix of the device may be derived through the total electron density. In the Green's function deriving step, a Green's function may be derived through the self-energy matrix. In the transmission function deriving step, a transmission function may be derived through the Green's function. In the current-voltage formula deriving step, a Landauer formula may be derived through the transmission function.

According to an embodiment of the present disclosure, a device analysis system and a device analysis method may be provided in which a device is simulated and non-equilibrium characteristics, partial characteristics, and partial non-equilibrium characteristics of the device are analyzed.

According to an embodiment of the present disclosure, non-equilibrium characteristics such as a non-equilibrium electron density, voltage-current characteristics, and non-equilibrium adsorption energy of the device may be derived.

According to an embodiment of the present disclosure, partial characteristics of the device such as a partial electron density of the device, partial polarization of the device, partial electron displacement of the device, partial dielectric constant of the device, and capacitance of the device may be derived.

According to an embodiment of the present disclosure, characteristics of an electrode unit having a finite thickness may be derived.

### BRIEF DESCRIPTION OF THE DRAWINGS

These and/or other features will become apparent and more readily appreciated from the following description of the embodiments, taken in conjunction with the accompanying drawings in which:

FIG. 1 illustrates an example of a device simulated in an embodiment of the present disclosure;

FIG. 2 illustrates an example of a device analysis system according to an embodiment of the present disclosure;

FIG. 3 is an example of a flowchart of a device analysis method according to an embodiment of the present disclosure;

FIG. 4 is an example of a flowchart of a total analysis step according to an embodiment of the present disclosure;

FIG. 5 is an example of a flowchart of a total electron density outputting step according to an embodiment of the present disclosure;

FIG. 6 is an example of a flowchart of a separated analysis step according to an embodiment of the present disclosure;

FIG. 7 is an example of a flowchart of a precision analysis step according to an embodiment of the present disclosure;

FIG. 8 is an example of a flowchart of a voltage-current characteristic deriving step according to an embodiment of the present disclosure;

FIG. 9 is an example of a flowchart of a charge storage and dielectric characteristic deriving step according to an embodiment of the present disclosure;

FIG. 10 is an example of a flowchart of a non-equilibrium adsorption energy deriving step according to an embodiment of the present disclosure;

FIG. 11 is a graph illustrating an inverse of a channel dielectric constant and an inverse of a total dielectric constant according to position, according to an experimental example of the present disclosure;

FIG. 12 is a capacitance graph according to an applied voltage, according to an experimental example of the present disclosure;

FIG. 13 is a graph illustrating an inverse of a channel dielectric constant and an inverse of a total dielectric constant according to position, according to an experimental example of the present disclosure;

FIG. 14 is a capacitance graph according to an applied voltage, according to an experimental example of the present disclosure; and

FIGS. 15 and 16 are graphs illustrating non-equilibrium adsorption energies of water molecules according to electric potential and distance from a first electrode, according to an experimental example of the present disclosure.

### DETAILED DESCRIPTION

References will now be made in detail to certain embodiments, of which examples are illustrated in the accompanying drawings, where like reference numerals refer to like elements throughout. The embodiments may have a variety of forms and permutations, but the present disclosure shall by no means be construed as being limited to the described embodiments. Rather, the present disclosure shall be construed to encompass all forms, permutations, equivalents and substitutes covered by the technical ideas and scope of the present disclosure. Accordingly, the embodiments are merely described below, by referring to the figures, to explain features of the present disclosure.

Before proceeding with a detailed description, it should be noted that the terminology and expressions used in this specification are not intended to be limited to conventional or dictionary-defined meanings. Rather, the terms and expressions are to be understood in the context of the concepts defined and utilized by the inventor to describe the disclosure in the most effective manner.

Moreover, these terms and expressions should be interpreted as meanings and concepts that are in line with the technical ideas and scope of the present disclosure. That is, the terms appearing in the present specification are used for the purpose of describing particular embodiments and are not intended to limit the disclosure. It shall be appreciated that these terms have been defined to encompass various possibilities within the scope of the present disclosure.

Furthermore, in the present specification, singular expressions shall be understood to include their plural counterparts unless dictated otherwise in the context. Similarly, plural expressions may encompass singular meanings when the context allows.

Throughout the specification, when an element is described as “including” another element, it does not necessarily mean that any other elements are precluded but may be further included, unless expressly stated otherwise. Furthermore, if an element is described as being “present inside” or “connected to” another element, it is intended to indicate that the element may be directly connected to or in contact with the other element.

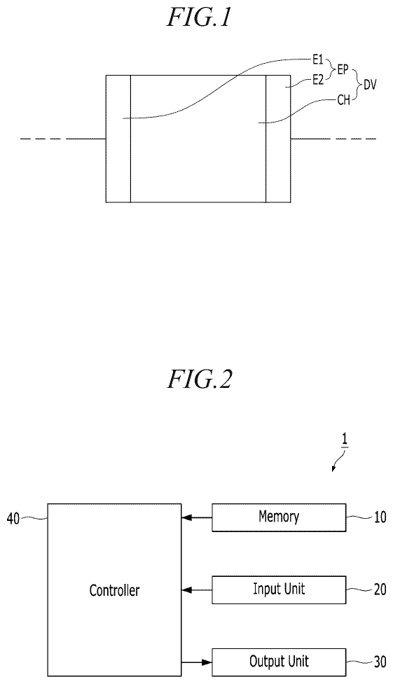

FIG. 1 illustrates an example of a device DV simulated in an embodiment of the present disclosure. FIG. 2 illustrates an example of a device analysis system 1 according to an embodiment of the present disclosure.

Referring to FIG. 1, the device DV may include an electrode unit EP and a channel CH. The device DV may be a capacitor. The device DV may be in an equilibrium state or a non-equilibrium state. When the device DV is in an equilibrium state, the electrode unit EP and the channel CH may be in an equilibrium state. When the device DV is in a non-equilibrium state, the electrode unit EP and the channel CH may be in a non-equilibrium state.

The device DV may be simulated. The simulated device DV may be analyzed. By analyzing the simulated device DV, characteristics of the device DV may be identified without a separate fabrication process, thereby allowing design of the device DV to be optimized.

The electrode unit EP may include a first electrode E1 and a second electrode E2. A voltage may be applied to the electrode unit EP. When no voltage is applied to the electrode unit EP, the device DV may be in an equilibrium state. When a voltage is applied to the electrode unit EP, the device DV may be in a non-equilibrium state.

The electrode unit EP may be a pair of conductive plates constituting a capacitor. When a voltage is applied to the electrode unit EP, electric charge may be accumulated in the electrode unit EP.

The first electrode E1 may be a finite electrode having a finite first thickness. The first electrode E1 may include gold or a graphene monolayer. However, the first thickness is not limited thereto. The first thickness may be infinite. In such a case, the first electrode E1 may be an infinite electrode.

The second electrode E2 may be a finite electrode having a finite second thickness. The second electrode E2 may include gold or a graphene monolayer. However, the second thickness is not limited thereto. The second thickness may be infinite. In such a case, the second electrode E2 may be an infinite electrode.

The channel CH may be disposed between the first electrode E1 and the second electrode E2. The channel CH may be a dielectric constituting a capacitor. The channel CH may include boron nitride or water.

Although FIG. 1 illustrates the device DV as a capacitor including two electrodes E1 and E2, the configuration of the device DV is not limited thereto. The device DV may include one electrode or three or more electrodes. The device DV may be a transistor, a light-emitting device, or the like.

Referring to FIG. 2, the device analysis system 1 may include a memory 10, an input unit 20, an output unit 30, and a controller 40. The device DV may be analyzed by the device analysis system 1. The device analysis system 1 may be implemented as a computer having a von Neumann architecture. However, the configuration of the device analysis system 1 is not limited thereto. The device analysis system 1 may be implemented in a cluster computing environment in which a plurality of computation nodes are interconnected through a network.

The memory 10 may be configured to store information. The memory 10 may be configured to exchange information with the controller 40. The memory 10 may include at least one of a volatile storage device and a non-volatile storage device.

The input unit 20 may be configured to receive information. Information input through the input unit 20 may be provided to the controller 40.

The output unit 30 may be configured to output information. The output unit 30 may be configured to output information provided from the controller 40.

The controller 40 may include at least one of a central processing unit (CPU), a graphics processing unit (GPU), a field-programmable gate array (FPGA), an application-specific integrated circuit (ASIC), a tensor processing unit (TPU), a neural processing unit (NPU), or a data processing unit (DPU). The controller 40 may be configured to perform computations through the above-described components. However, the configuration of the controller 40 is not limited thereto.

The controller 40 may be configured to simulate the device DV. The controller 40 may be configured to analyze the simulated device DV. The controller 40 may be configured to analyze the device DV through a first-principles methodology. The controller 40 may be configured to analyze the device DV through a density functional theory and a non-equilibrium Green's function methodology. However, the method by which the controller 40 analyzes the device DV is not limited thereto.

The controller 40 may be configured to perform a total analysis on the device DV. The controller 40 may be configured to analyze the simulated device DV to derive characteristics of the device DV. For example, the controller 40 may be configured to derive a total electron density (ρ_{T}). The total electron density (ρ_{T}) may be defined as a probability density of electrons distributed in the device DV. The total electron density (ρ_{T}) may be a probability density function that varies according to position.

The controller 40 may be configured to simulate the device DV to derive non-equilibrium characteristics of the device DV. For example, the controller 40 may be configured to derive a non-equilibrium total electron density

$$( {ρ}_{T}^{V} ) .$$

The total electron density (ρ_{T}) may include an equilibrium total electron density

$$( {ρ}_{T}^{0} )$$

defined as a total electron density (ρ_{T}) in an equilibrium state and a non-equilibrium total electron density

$$( {ρ}_{T}^{V} )$$

defined as a total electron density (ρ_{T}) in a non-equilibrium state.

The controller 40 may be configured to set an initial total electron density (ρ_{TF}). The initial total electron density (ρ_{TF}) may be a value or function predicted by the total electron density (ρ_{T}). The initial total electron density (ρ_{TF}) may be an equilibrium total electron density

$$( {ρ}_{T}^{0} )$$

derived through the density functional theory. The initial total electron density (ρ_{TF}) may be substantially different from an actual total electron density (ρ_{T}). For example, the initial total electron density (ρ_{TF}) may be an equilibrium total electron density

$$( {ρ}_{T}^{V} ) ,$$

whereas the total electron density (ρ_{T}) may be a non-equilibrium total electron density

$$( {ρ}_{T}^{V} ) .$$

The controller 40 may be configured to set an input total electron density (ρ_{TI}). The input total electron density (ρ_{TI}) may be a value or function set by substituting the initial total electron density (ρ_{TF}) into the input total electron density (ρ_{TI}).

The controller 40 may be configured to derive total electron states through the input total electron density (ρ_{TI}). The total electron states may be electron states of electrons constituting the entire device DV. The total electron states may include energy levels (εᵢ) of respective electron states and wavefunctions (ψᵢ) of the respective electron states. The wavefunction (ψᵢ) of each electron state may be derived through Equation 1.

$${ψ}_{i} = {\sum }_{μ} {χ}_{μ} ( \vec{r} ) {c}_{μ i} \qquad 〈 Equation 1 〉$$

(where χ_{μ}(\vec{r}) is a spatial basis function, and c_{μi} is a basis-function coefficient of each electron state.)

Referring to Equation 1, the spatial basis function (χ_{μ}(\vec{r}) may be a function representing an atomic orbital. The basis-function coefficient (c_{μi}) may be a coefficient corresponding to the spatial basis function (χ_{μ}(\vec{r}). The wavefunction (ψᵢ) of each electron state may be derived through the spatial basis function (χ_{μ}(\vec{r}) and the basis-function coefficient (c_{μi}).

The energy level (εᵢ) and the basis-function coefficient (c_{μi}) of each electron state may be derived through Equation 2. The wavefunction (ψᵢ) of each electron state may be derived through the basis-function coefficient (c_{μi}) derived through Equation 2.

$${\sum }_{μ} ( H [ {ρ}_{T l} ] ) ( {c}_{μ i} ) = {ε}_{i} {\sum }_{μ} ( S [ {ρ}_{T l} ] ) ( {c}_{μ i} ) \qquad 〈 Equation 2 〉$$

(where H[x] is a Kohn-Sham Hamiltonian matrix, ρ_{TI} is the input total electron density, c_{μi} is a basis-function coefficient of an electron state, εᵢ is an energy level of each electron state, and S[x] is an overlap matrix.)

Referring to Equation 2, the Kohn-Sham Hamiltonian matrix (H[x]) may be a functional that derives a Hamiltonian matrix when an electron density is substituted into x. The overlap matrix (S[x]) may be a functional that derives an overlap matrix when an electron density is substituted into x. By substituting the input total electron density (ρ_{TI}) into the Kohn-Sham Hamiltonian matrix (H[x]) and the overlap matrix (S[x]), the energy level (εᵢ) of each electron state and the basis-function coefficient (c_{μi}) of each electron state may be derived.

Equation 2 may be calculated through Brillouin-zone integration using a plurality of sampling points. A value calculated through the Brillouin-zone integration may be an approximate value.

The controller 40 may be configured to derive a total electron number (N₀) through the total electron states. The total electron number (N₀) may be the number of electrons constituting the device DV.

The total electron number (N₀) may be derived through Equations 3 and 4.

$${f}_{i} = \frac{1}{1 + {e}^{- ( {ε}_{i} - μ ) / {k}_{B} T}} \qquad 〈 Equation 3 〉$$

(where fᵢ is an occupation probability of each electron state, μ is an electrochemical potential, k_{B} is a Boltzmann constant, and T is an absolute temperature.)

Referring to Equation 3, the occupation probability (fᵢ) of each electron state may be derived through the energy level (εᵢ) of each electron state, the electrochemical potential (μ), the Boltzmann constant (k_{B}), and the absolute temperature (T).

$${\sum }_{i} {f}_{i} = {N}_{0} \qquad 〈 Equation 4 〉$$

(where fᵢ is an occupation probability of each electron state, and N₀ is the total electron number.)

Referring to Equation 4, the total electron number (N₀) may be derived through the occupation probability (fₜ) of each electron state. Equation 4 may be calculated through Brillouin-zone integration using a plurality of sampling points.

The controller 40 may be configured to derive a plurality of partial electron states through the total electron states. Each of the plurality of partial electron states may be an electron state of electrons constituting a part of the device DV. The plurality of partial electron states may include a plurality of partial energy levels (ε_{P}) and a plurality of partial wavefunctions (ψ_{P}).

The plurality of partial energy levels (ε_{P}) and the plurality of partial wavefunctions (ρ_{P}) may be defined by separating the total electron states based on position.

The plurality of partial energy levels (ε_{P}) may include electrode-unit energy levels (ε_{EP}) and channel energy levels (ε_{CH}). The electrode-unit energy levels (ε_{EP}) may include first-electrode energy levels (ε_{E1}) and second-electrode energy levels (ε_{E2}).

The plurality of partial wavefunctions (ψ_{P}) may include electrode-unit wavefunctions (ψ_{EP}) and channel wavefunctions (ψ_{CH}). The electrode-unit wavefunctions (ψ_{EP}) may include first-electrode wavefunctions (ψ_{E1}) and second-electrode wavefunctions (ψ_{E2}).

The first-electrode wavefunction (ψ_{E1}) may be a wavefunction among the wavefunctions (ψ_{EP}) of the respective electron states that satisfies the condition of Equation 5. The second-electrode wavefunction (ψ_{E2}) may be a wavefunction among the wavefunctions (ψᵢ) of the respective electron states that satisfies the condition of Equation 6. The channel wavefunction (ψ_{CH}) may be a wavefunction among the wavefunctions (ψᵢ) of the respective electron states that satisfies the condition of Equation 7.

$${\int }_{E 1} {\vert {ψ}_{i} \vert}^{2} {d}^{3} r > max ( {\int }_{C H} {\vert {ψ}_{i} \vert}^{2} {d}^{3} r , {\int }_{E 2} {\vert {ψ}_{i} \vert}^{2} {d}^{3} r ) \qquad 〈 Equation 5 〉$$

(where ψᵢ is a wavefunction of each electron state, and max( ) is an operator that returns a larger value among the terms in the parentheses.)

Referring to Equation 5, the first-electrode wavefunction (ψ_{E1}) may be derived by spatially integrating the wavefunction (ψᵢ) of each electron state over a region corresponding to the position of the first electrode E1, a region corresponding to the position of the channel CH, and a region corresponding to the position of the second electrode E2. The first-electrode wavefunction (ψ_{E1}) may be a wavefunction among the wavefunctions (ψᵢ) of the respective electron states that satisfies the condition of Equation 5.

$${\int }_{E 2} {\vert {ψ}_{i} \vert}^{2} {d}^{3} r > max ( {\int }_{C H} {\vert {ψ}_{i} \vert}^{2} {d}^{3} r , {\int }_{E 1} {\vert {ψ}_{i} \vert}^{2} {d}^{3} r ) \qquad 〈 Equation 6 〉$$

(where ψᵢ is a wavefunction of each electron state, and max( ) is an operator that returns a larger value among the terms in the parentheses.)

Referring to Equation 6, the second-electrode wavefunction (ψ_{E2}) may be derived by comparing spatially integrated values. The second-electrode wavefunction (ψ_{E2}) may be a wavefunction among the wavefunctions (ψᵢ) of the respective electron states that satisfies the condition of Equation 6.

$${\int }_{CH} {\vert {ψ}_{i} \vert}^{2} {d}^{3} r > max ( {\int }_{E 1} {\vert {ψ}_{i} \vert}^{2} {d}^{3} r , {\int }_{E 2} {\vert {ψ}_{i} \vert}^{2} {d}^{3} r ) \qquad 〈 Equation 7 〉$$

(where ψᵢ is a wavefunction of each electron state, and max( ) is an operator that returns a larger value among the terms in the parentheses.)

Referring to Equation 7, the channel wavefunction (ψ_{CH}) may be derived by comparing spatially integrated values. The channel wavefunction (ψ_{CH}) may be a wavefunction among the wavefunctions (ψᵢ) of the respective electron states that satisfies the condition of Equation 7.

The controller 40 may be configured to set a plurality of initial electrochemical potentials (μ_{F}). The plurality of initial electrochemical potentials (μ_{F}) may include an initial electrochemical potential (μ_{F1}) of the first electrode, an initial electrochemical potential (μ_{F2}) of the second electrode, and an initial electrochemical potential (μ_{FC}) of the channel. A difference between the initial electrochemical potential (μ_{F1}) of the first electrode and the initial electrochemical potential (μ_{F2}) of the second electrode may be derived through a value obtained by multiplying an elementary charge (e) of an electron and a voltage (V) applied to the electrode unit EP.

The controller 40 may be configured to set a plurality of input electrochemical potentials (μᵢ) through the plurality of initial electrochemical potentials (μ_{F}). The plurality of input electrochemical potentials (μᵢ) may include an input electrochemical potential (μᵢ₁) of the first electrode, an input electrochemical potential (μᵢ₂) of the second electrode, and an input electrochemical potential (μ_{iC}) of the channel.

The controller 40 may be configured to derive a plurality of partial electron numbers (N_{P}) through the plurality of input electrochemical potentials (μᵢ) and the plurality of partial electron states. Each of the plurality of partial electron numbers (N_{P}) may be defined as the number of electrons constituting a part of the device DV.

The plurality of partial electron numbers (N_{P}) may include an electrode-unit electron number (N_{EP}) defined as the number of electrons constituting the electrode unit EP and a channel electron number (N_{CH}) defined as the number of electrons constituting the channel CH. The electrode-unit electron number (N_{EP}) may include a first-electrode electron number (N_{E1}) and a second-electrode electron number (N_{E2}).

The controller 40 may be configured to derive partial occupation probabilities (fₚ) through the plurality of input electrochemical potentials (μᵢ) and the plurality of partial energy levels (εₚ) and derive each partial electron number (N_{P}) through the partial occupation probabilities. For example, by substituting channel energy levels (ε_{CH}) and the input electrochemical potential (μ_{iC}) of the channel into Equation 3, an occupation probability (f_{CH}) of a channel defined as the occupation probability (fᵢ) of each electron state in the channel CH may be derived. Moreover, by substituting the occupation probability (f_{CH}) of the channel into Equation 4, the channel electron number (N_{CH}) may be derived. The first-electrode electron number (N_{E1}) and the second-electrode electron number (N_{E2}) may also be derived through the same method.

The controller 40 may be configured to compare the total electron number (N₀) and a sum of the plurality of partial electron numbers (N_{P}) and derive a plurality of output electrochemical potentials (μ₀) through the plurality of input electrochemical potentials (μᵢ).

The total electron number (N₀), which is the total number of electrons constituting the device DV, and the sum of the plurality of partial electron numbers (N_{P}), which is a sum of numbers of electrons constituting respective parts of the device DV, may be identical to each other. Accordingly, when the total electron number (N₀) and the sum of the plurality of partial electron numbers (N_{P}) are different from each other, the controller 40 may be configured to derive a plurality of output electrochemical potentials (μ₀) different from the plurality of input electrochemical potentials (μᵢ) such that the total electron number (N₀) and the sum of the plurality of partial electron numbers (N_{P}) become closer to each other.

The controller 40 may be configured to, when a value obtained by subtracting a sum of the plurality of partial electron numbers (N_{P}) from the total electron number (N₀) is greater than a first convergence criterion, derive an output electrochemical potential (μ_{O1}) of the first electrode having a value obtained by adding a potential increment to the input electrochemical potential (μᵢ₁) of the first electrode, and derive an output electrochemical potential (μ_{O2}) of the second electrode having a value obtained by adding the potential increment to the input electrochemical potential (μᵢ₂) of the second electrode.

The controller 40 may be configured to, when a value obtained by subtracting the sum of the plurality of partial electron numbers (N_{P}) from the total electron number (N₀) is less than the first convergence criterion, derive an output electrochemical potential (μ_{O1}) of the first electrode having a value obtained by subtracting a potential decrement from the input electrochemical potential (μᵢ₁) of the first electrode, and derive an output electrochemical potential (μ_{O2}) of the second electrode having a value obtained by subtracting the potential decrement from the input electrochemical potential (μᵢ₂) of the second electrode.

Accordingly, a difference between the input electrochemical potential (μᵢ₁) of the first electrode and the input electrochemical potential (μᵢ₂) of the second electrode may be substantially identical to a difference between the output electrochemical potential (μ_{O1}) of the first electrode and the output electrochemical potential (μ_{O2}) of the second electrode.

When the plurality of output electrochemical potentials (μ₀) different from the plurality of input electrochemical potentials (μᵢ) are derived, the controller 40 may be configured to substitute the plurality of output electrochemical potentials (μ_{O}) into the plurality of input electrochemical potentials (μᵢ) to reset the plurality of input electrochemical potentials (μᵢ). The controller 40 may be configured to re-derive the plurality of partial electron numbers (N_{P}) through the reset plurality of input electrochemical potentials (μᵢ).

The controller 40 may be configured to, when a difference between the total electron number (N₀) and the sum of the plurality of partial electron numbers (N_{P}) is less than or equal to the first convergence criterion, derive the plurality of output electrochemical potentials (μ_{O}) to be identical to the plurality of input electrochemical potentials (μᵢ). The plurality of output electrochemical potentials (μₒ) derived when the difference between the total electron number (N₀) and the sum of the plurality of partial electron numbers (N_{P}) is less than or equal to the first convergence criterion may be a plurality of final electrochemical potentials (μ_{L}). As a result, the plurality of output electrochemical potentials (μ_{O}) may be adjusted through the controller 40, and non-equilibrium characteristics of the device DV may be derived more accurately.

The controller 40 may be configured to re-derive an occupation probability (fᵢ) of each electron state through the plurality of output electrochemical potentials (μ_{O}). That is, the occupation probability (fᵢ) of each electron state may be reset through the adjusted plurality of output electrochemical potentials (μ_{O}). Accordingly, the occupation probability (fᵢ) of each electron state may be derived more accurately. Specifically, the controller 40 may be configured to re-derive the occupation probability (fᵢ) of each electron state through Equation 3.

The controller 40 may be configured to derive an output total electron density (ρ_{TO}) through the occupation probability (fᵢ) of each electron state and the wavefunction (ψᵢ) of each electron state. The total electron density (ρ_{TO}) may be more accurately derived since it is derived through the reset occupation probability (fᵢ) of each electron state. The output total electron density (ρ_{TO}) may be derived through Equations 8 and 9.

$${D}_{μ v} = {\sum }_{λ} {f}_{i} {c}_{i μ} {c}_{i v}^{*} \qquad 〈 Equation 8 〉$$

(where D_{μv} is an electron density matrix, fᵢ is an occupation probability of each electron state, c_{iμ} and cᵢᵥ are basis-function coefficients of each electron state, and * denotes a complex conjugate.)

Referring to Equation 8, the electron density matrix (D_{μν}) may be derived through the occupation probability (fᵢ) of each electron state and the basis-function coefficients (c_{iμ}, cᵢᵥ) of each electron state. The basis-function coefficients (c_{iμ}, cᵢᵥ) may be coefficients constituting the wavefunction (ψᵢ) of each electron state. Equation 8 may be calculated through Brillouin-zone integration using a plurality of sampling points.

$$n ( \vec{r} ) = {\sum }_{μ v} {D}_{μ v} {χ}_{μ} ( \vec{r} ) {χ}_{v}^{*} ( \vec{r} ) \qquad 〈 Equation 9 〉$$

(where n(\vec{r}) is an electron density at a spatial coordinate R, D_{μv} is an electron density matrix, χ_{μ}(\vec{r}) and χ_{μ}(\vec{r}) are basis functions, and * denotes a complex conjugate.

Referring to Equation 9, the electron density (n(\vec{r})) at the spatial coordinate R may be derived through the electron density matrix (D_{μv}) and the basis functions (χ_{μ}(\vec{r}), χ_{μ}(\vec{r})). The basis functions (χ_{μ}(\vec{r}), χ_{μ}(\vec{r})) may be functions used to expand the wavefunction (ψ). Equation 9 may be calculated through Brillouin-zone integration using a plurality of sampling points. The output total electron density (ρ_{TO}) may be derived through the electron density (n(\vec{r})) at the spatial coordinate R.

The controller 40 may be configured to derive a potential of the output total electron density (ρ_{TO}). For example, the controller 40 may be configured to derive at least one of a Hartree potential (v_{H}), an exchange-correlation potential (v_{xc}), an external potential (vₑₓₜ), and an effective potential (v_{eff}) of the output total electron density (ρ_{TO}).

The controller 40 may be configured to determine whether a difference between a potential of an input total electron density (ρ_{TI}) and a potential of the output total electron density (ρ_{TO}) is less than or equal to a second convergence criterion. For example, the controller 40 may be configured to determine whether a difference between a Hartree potential (v_{H}) of the input total electron density (ρ_{TI}) and a Hartree potential (v_{H}) of the output total electron density (ρ_{TO}) is less than or equal to the second convergence criterion.

The controller 40 may be configured to, when the difference between the potential of the input total electron density (ρ_{TI}) and the potential of the output total electron density (ρ_{TO}) exceeds the second convergence criterion, substitute a value of the output total electron density (ρ_{TO}) into the input total electron density (ρ_{TI}). Accordingly, the input total electron density (ρ_{TI}) may be reset. The controller 40 may be configured to re-derive at least one of a partial occupation probability (fₚ) and a wavefunction (ψᵢ) of each electron state through the reset input total electron density (ρ_{T}). The controller 40 may be configured to re-derive the output total electron density (ρ_{TO}) through the partial occupation probability (fₚ) and the wavefunction (ψᵢ) of each electron state. The controller 40 may be configured to determine again whether the difference between the potential of the input total electron density (ρ_{TI}) and the potential of the output total electron density (ρ_{TO}) is less than or equal to the second convergence criterion.

The controller 40 may be configured to, when the difference between the potential of the input total electron density (ρ_{TI}) and the potential of the output total electron density (ρ_{TO}) is less than or equal to the second convergence criterion, derive the total electron density (ρ_{T}) through the output total electron density (ρ_{TO}). The controller 40 may be configured to, when the difference between the potential of the input total electron density (ρ_{TI}) and the potential of the output total electron density (ρ_{TO}) is less than or equal to the second convergence criterion, substitute the output total electron density (ρ_{TO}) into a final total electron density (ρ_{TL}). The total electron density (ρ_{T}) may be derived through the final total electron density (ρ_{TL}).

The final total electron density (ρ_{TL}) may be substantially one of the total electron densities (ρ_{T}). The final total electron density (ρ_{TL}) may be a non-equilibrium total electron density

$$( {ρ}_{T}^{V} ) .$$

Non-equilibrium characteristics of the device DV derived by the controller 40 are not limited to a non-equilibrium total electron density

$$( {ρ}_{T}^{V} ) .$$

The controller 40 may be configured to further derive non-equilibrium characteristics such as a non-equilibrium total energy

$$( {E}_{T}^{V} )$$

and a non-equilibrium electrode-unit energy

$$( {E}_{E P}^{V} ) .$$

A non-equilibrium total energy

$$( {E}_{T}^{V} )$$

may be defined as a total energy of the device DV in a non-equilibrium state. The non-equilibrium total energy

$$( {E}_{T}^{V} )$$

may be derived by substituting a non-equilibrium total electron density

$$( {ρ}_{T}^{V} )$$

for a total electron density (ρ_{T}) in a conventional method in which a total energy (E_{T}) is derived through density functional theory using the total electron density (ρ_{T}).

A non-equilibrium electrode-unit energy

$$( {E}_{E P}^{V} )$$

may be defined as a total energy of the electrode unit EP when the device DV is in a non-equilibrium state.

An equilibrium channel energy

$$( {E}_{C H}^{0} )$$

may be defined as a total energy of the channel CH when the device DV is in an equilibrium state.

In addition, analysis of the first electrode E1 and the second electrode E2 having finite thicknesses may be possible through the controller 40.

The controller 40 may be configured to perform a separated analysis on the device DV. The controller 40 may be configured to simulate the device DV to derive partial characteristics of the device DV. For example, the controller 40 may be configured to derive a partial electron density (ρₚ). The partial electron density (ρₚ) may be defined as a probability density of electrons distributed in a part of the device DV. The partial electron density (ρₚ) may be a probability density function that varies according to position. The partial electron density (ρₚ) may have a non-zero value even at a position separated from the part of the device DV.

The total electron density (ρ_{T}) used in the separated analysis process for the device DV may be one derived in the total analysis process for the device DV. The total electron density (ρ_{T}) used in the separated analysis process for the device DV may be a separate value obtained by a different method. For example, the total electron density (ρ_{T}) used in the separated analysis process for the device DV may be a value generated through an artificial neural network.

The partial electron density (ρₚ) may include at least one of an electrode-unit electron density (ρ_{EP}) defined as a probability density of electrons distributed in the electrode unit EP, a first-electrode electron density (ρ_{E1}) defined as a probability density of electrons distributed in the first electrode E1, a second-electrode electron density (ρ_{E2}) defined as a probability density of electrons distributed in the second electrode E2, and a channel electron density (ρ_{CH}) defined as a probability density of electrons distributed in the channel CH.

The partial electron density (ρₚ) may include an equilibrium partial electron density

$$( {ρ}_{P}^{0} )$$

and a non-equilibrium partial electron density

$$( {ρ}_{P}^{V} ) .$$

The equilibrium partial electron density

$$( {ρ}_{P}^{0} )$$

may be defined as a probability density of electrons distributed in a part of the device DV in an equilibrium state. The non-equilibrium partial electron density

$$( {ρ}_{P}^{V} )$$

may be defined as a probability density of electrons distributed in a part of the device DV in a non-equilibrium state.

For example, the electrode-unit electron density (ρ_{EP}) may include an equilibrium electrode-unit electron density

$$( {ρ}_{E P}^{0} )$$

and a non-equilibrium electrode-unit electron density

$$( {ρ}_{E P}^{V} ) .$$

The channel electron density (ρ_{CH}) may include an equilibrium channel electron density

$$( {ρ}_{C H}^{0} )$$

and a non-equilibrium channel electron density

$$( {ρ}_{C H}^{V} ) .$$

The controller 40 may be configured to set an initial partial electron density (ρ_{PF}). The initial partial electron density (ρ_{PF}) may be a predicted value or function of one of the partial electron densities (ρₚ). The initial partial electron density (ρ_{PF}) may be a total electron density (ρ_{T}) derived in the total analysis process or a total electron density (ρ_{T}) generated through an artificial neural network. The initial partial electron density (ρ_{PF}) may be substantially different from the partial electron density (ρₚ). The initial partial electron density (ρ_{PF}) may be a predicted value of a non-equilibrium channel electron density

$$( {ρ}_{C H}^{V} ) .$$

The controller 40 may be configured to set an input partial electron density (ρ_{PI}). The input partial electron density (ρ_{PI}) may be a value or function set by substituting the initial partial electron density (ρ_{PF}) into the input partial electron density (ρ_{PI}).

The controller 40 may be configured to derive a first potential (v₁) through the input partial electron density (ρ_{PI}).

The first potential (v₁) may be derived through Equation 10 below.

$${f}_{1} [ {ρ}_{P l} ] = {v}_{1} = {v}_{eff} = {v}_{ext} + {v}_{H} + {v}_{x c} \qquad 〈 Equation 10 〉$$

(where fᵢ is a first functional, ρ_{PI} is the input partial electron density, v₁ is the first potential, V_{eff} is an effective potential, Vₑₓₜ is an external potential, v_{H} is a Hartree potential, and v_{xc} is an exchange-correlation potential.)

Referring to Equation 10, the first potential (v₁) may be derived as a value obtained by substituting the input partial electron density (ρ_{PI}) into the first functional (fᵢ). The first functional (fᵢ) may be a functional that derives an effective potential (v_{eff}) in density functional theory when a probability density function is substituted. The effective potential (v_{eff}) may be represented, in density functional theory, as a sum of an external potential (vₑₓₜ), a Hartree potential (v_{H}), and an exchange-correlation potential (v_{xc}).

The controller 40 may be configured to derive a second potential (v₂) through the input partial electron density (ρ_{PI}) and the total electron density (ρ_{T}). The second potential (v₂) may be derived through Equation 11 below.

$${f}_{2} [ {ρ}_{T} ] - {f}_{2} [ {ρ}_{Pl} ] = {v}_{2} = {v}_{T H} - {v}_{P H} \qquad 〈 Equation 11 〉$$

(where f₂ is a second functional, ρ_{T} is the total electron density, ρ_{pI} is the input partial electron density, v₂ is the second potential, v_{TH} is a total Hartree potential, and v_{PH} is a partial Hartree potential.)

Referring to Equation 11, the second potential (v₂) may be derived as a value obtained by subtracting a value obtained by substituting the input partial electron density (ρ_{P1}) into the second functional (f₂) from a value obtained by substituting the total electron density (ρ_{T}) into the second functional (f₂).

The second functional (f₂) may be a functional that derives a Hartree potential (v_{H}) when a probability density function is substituted. By substituting the total electron density (ρ_{T}) into the second functional (f₂), the total Hartree potential (v_{TH}) may be derived. By substituting the input partial electron density (ρ_{PI}) into the second functional (f₂), the partial Hartree potential (v_{PH}) may be derived. The second potential (v₂) may be derived as a value obtained by subtracting the partial Hartree potential (v_{PH}) from the total Hartree potential (v_{TH}).

The controller 40 may be configured to derive an output partial electron density (ρ_{PO}) through the first potential (v₁) and the second potential (v₂). The output partial electron density (ρ_{PO}) may be derived through Equations 12 and 13 below.

$$[ \frac{1}{2} {∇}^{2} + {v}_{1} + {v}_{2} ] {ψ}_{i} = {E}_{i} {ψ}_{i} \qquad 〈 Equation 12 〉$$

(where

$$\frac{1}{2} {∇}^{2}$$

is a kinetic energy operator, v₁ is the first potential, v₂ is the second potential, ψᵢ is a Kohn-Sham orbital, and Eᵢ is an energy of the Kohn-Sham orbital.)

Equation 12 may correspond to a Kohn-Sham equation in density functional theory to which a second-potential term (v₂) is added. Brackets on the left-hand side may represent a Hamiltonian in the Kohn-Sham equation. The Kohn-Sham orbital (ψᵢ) may be a wavefunction. A solution of the Kohn-Sham orbital (ψᵢ) of Equation 12 may be derived through a method for obtaining a solution of a conventional Kohn-Sham equation.

$${ρ}_{P O} = {\sum }_{i}^{N} \vert {ψ}_{i} {\vert}^{2} \qquad 〈 Equation 13 〉$$

(where ρ_{PO} is the output partial electron density, ψᵢ is a Kohn-Sham orbital, and N is a number of occupied electrons.)

By substituting the Kohn-Sham orbital (ψᵢ) into Equation 13, the output partial electron density (ρ_{PO}) may be derived. As a result, the output partial electron density (ρ_{PO}) may be a value or function derived through the input partial electron density (ρ_{PI}) and the total electron density (ρ_{T}).

The controller 40 may be configured to determine whether a difference between the input partial electron density (ρ_{PI}) and the output partial electron density (ρ_{PO}) is less than or equal to a third convergence criterion.

The controller 40 may be configured to, when the difference between the input partial electron density (ρ_{PI}) and the output partial electron density (ρ_{PO}) exceeds the third convergence criterion, substitute a value of the output partial electron density (ρ_{PO}) into the input partial electron density (ρ_{PI}). Accordingly, the input partial electron density (ρ_{PI}) may be reset. The controller 40 may be configured to re-derive the first potential (v₁) through the input partial electron density (ρ_{PI}). The controller 40 may be configured to re-derive the second potential (v₂) through the input partial electron density (ρ_{PI}) and the total electron density (ρ_{T}). The controller 40 may be configured to re-derive the output partial electron density (ρ_{PO}) through the first potential (v₁) and the second potential (v₂). The controller 40 may be configured to again determine whether the difference between the input partial electron density (ρ_{PI}) and the output partial electron density (ρ_{PO}) is less than or equal to the third convergence criterion.

The controller 40 may be configured to, when the difference between the input partial electron density (ρ_{PI}) and the output partial electron density (ρ_{PO}) is less than or equal to the third convergence criterion, derive the partial electron density (ρₚ) through the output partial electron density (ρ_{PO}). The controller 40 may be configured to, when the difference between the input partial electron density (ρ_{PI}) and the output partial electron density (ρ_{PO}) is less than or equal to the third convergence criterion, substitute the output partial electron density (ρ_{PO}) into a final partial electron density (ρ_{PL}). The partial electron density (ρₚ) may be derived through the final partial electron density (ρ_{PL}).

The final partial electron density (ρ_{PL}) may substantially be a value of one of the partial electron densities (ρₚ). The final partial electron density (ρ_{PL}) may vary according to the initial partial electron density (ρ_{PF}). For example, when the initial partial electron density (ρ_{PF}) is a predicted value of a non-equilibrium channel electron density

$$( {ρ}_{C H}^{V} ) ,$$

the final partial electron density (ρ_{PL}) may be the non-equilibrium channel electron density

$$( {ρ}_{C H}^{V} ) .$$

Another part of the partial electron density (ρₚ) may be derived through a part of the partial electron density (ρₚ). For example, the total electron density (ρ_{T}) may be identical to a sum of the partial electron densities (ρₚ). Accordingly, another part of the partial electron density (ρₚ) may be derived through a part of the partial electron density (ρₚ) and the total electron density (ρ_{T}).

Further, a sum of equilibrium partial electron densities

$$( {ρ}_{P}^{0} )$$

may be identical to an equilibrium total electron density

$$( {ρ}_{T}^{0} ) .$$

A sum of non-equilibrium partial electron densities

$$( {ρ}_{P}^{V} )$$

may be identical to a non-equilibrium total electron density

$$( {ρ}_{T}^{V} ) .$$

Accordingly, the above-described method may be applied in the same manner to the equilibrium partial electron density

$$( {ρ}_{P}^{0} )$$

and the non-equilibrium partial electron density

$$( {ρ}_{P}^{V} ) .$$

The controller 40 may be configured to derive a plurality of partial electron densities (ρₚ). The controller 40 may be configured to derive the plurality of partial electron densities (ρₚ) by repeatedly performing the separated analysis process. The controller 40 may be configured to compare a sum of the plurality of partial electron densities (ρₚ) with the total electron density (ρ_{T}).

The controller 40 may be configured to, when a difference between the total electron density (ρ_{T}) and the sum of the plurality of partial electron densities (ρₚ) is less than or equal to a reliability threshold value, classify the total electron density (ρ_{T}) and the plurality of partial electron densities (ρₚ) as high-reliability data. By training an artificial neural network that derives the total electron density (ρ_{T}) through the total electron density (ρ_{T}) and the plurality of partial electron densities (ρₚ) classified as high-reliability data, the initial partial electron density (ρ_{PF}) may be provided more appropriately and the separated analysis may be performed more rapidly.

The controller 40 may be configured to, when the difference between the total electron density (ρ_{T}) and the sum of the plurality of partial electron densities (ρₚ) exceeds the reliability threshold value, re-derive at least one of the total electron density (ρ_{T}) and the plurality of partial electron densities (ρₚ). Accordingly, reliability of the total electron density (ρ_{T}) and the plurality of partial electron densities (ρₚ) may be further improved. However, the configuration of the controller 40 is not limited to the above. The controller 40 may not compare the sum of the plurality of partial electron densities (ρₚ) with the total electron density (ρ_{T}).

The controller 40 may be configured to perform a precision analysis on the device DV. The controller 40 may be configured to derive partial non-equilibrium characteristics of the device DV. For example, the controller 40 may be configured to derive a voltage-current characteristic, a partial polarization (P̅_{P}), a partial electric displacement (D̅_{P}), a partial dielectric constant (ϵ_{rP}), a total capacitance (C_{T}), a geometric capacitance (C_{g}), a quantum capacitance (C_{q}), and a non-equilibrium adsorption energy

$$( Δ {F}_{C H}^{V} ) .$$

The voltage-current characteristic may be an equation of a current according to a voltage applied to the device DV. The voltage-current characteristic may be determined through a Landauer formula.

The voltage-current characteristic may be derived through the non-equilibrium total electron density

$$( {ρ}_{T}^{V} ) .$$

The voltage-current characteristic may be derived through different methods according to a shape of the electrode unit EP. For example, when the electrode unit EP is an infinite electrode and when the electrode unit EP is a finite electrode, the voltage-current characteristic may be derived through different methods.

The voltage-current characteristic may be derived through Equations 14, 15, 16, 17, and 18 below. When the electrode unit EP is an infinite electrode, the voltage-current characteristic may be derived through Equations 14, 15, 16, and 18, and when the electrode unit EP is a finite electrode, the voltage-current characteristic may be derived through Equations 14, 15, 17, and 18.

$$\sum = {τg}_{s} {τ}^{†} \qquad 〈 Equation 14 〉$$

(where Σ is a self-energy matrix, τ is a coupling matrix, gₛ is a surface Green's function, and t denotes a Hermitian conjugate.)

Referring to Equation 14, a self-energy matrix (Σ) of the device DV may be derived through a coupling matrix (τ) and a surface Green's function (gₛ) of the device DV. When the electrode unit EP is an infinite electrode, the surface Green's function (gₛ) may be derived through density functional theory or a non-equilibrium Green's function. When the electrode unit EP is a finite electrode, the surface Green's function (gₛ) may be derived through data corresponding to an electrode portion of a Kohn-Sham Hamiltonian matrix (H[x]) after the total electron density (ρ_{T}) is substituted into the Kohn-Sham Hamiltonian matrix (H[x]). Through Equation 14, a self-energy matrix (Σ_{E1}) of the first electrode and a self-energy matrix (Σ_{E2}) of the second electrode may be derived.

$$G = {( EI - H [ {ρ}_{T}^{V} ] - {\sum }_{E 1} - {\sum }_{E 2} )}^{- 1} \qquad 〈 Equation 15 〉$$

(where G is a Green's function, EI is an energy matrix, H[x] is a Kohn-Sham Hamiltonian matrix,

$${ρ}_{T}^{V}$$

is a non-equilibrium total electron density, Σ_{E1} is the self-energy matrix of the first electrode, and Σ_{E2} is the self-energy matrix of the second electrode.)

Referring to Equation 15, the Green's function (G) may be derived through the energy matrix (EI), the Kohn-Sham Hamiltonian matrix (H[x]), the non-equilibrium total electron density

$$( {ρ}_{T}^{V} ) ,$$

the self-energy matrix (Σ_{E1}) of the first electrode, and the self-energy matrix (Σ_{E2}) of the second electrode. The energy matrix (EI) may be a matrix derived by multiplying an energy-level variable (E) of an electron state and an identity matrix (I).

$$T ( E ; {V}_{b} ) = T r [ {Γ}_{E 1} G {Γ}_{E 2} {G}^{†} ] \qquad 〈 Equation 16 〉$$

(where T(E; V_{b}) is a transmission function, Tr[x] is a trace function, Γ_{E1} is a broadening coupling matrix of the first electrode, G is the Green's function, Γ_{E2} is a broadening coupling matrix of the second electrode, and † denotes a Hermitian conjugate)

Referring to Equation 16, the transmission function (T(E; V_{b})) may be derived through the trace function (Tr[x]), the broadening coupling matrix (Γ_{E1}) of the first electrode, the Green's function (G), and the broadening coupling matrix (Γ_{E2}) of the second electrode. The trace function (Tr[x]) may be a function that derives a sum of diagonal components when a matrix x is substituted. The broadening coupling matrix (Γ) may be derived through the self-energy matrix (Σ).

In Equation 16, the Green's function (G) derived under a condition in which the electrode unit EP is an infinite electrode may be substituted. Equation 16 may be an equation for deriving the transmission function (T(E; V_{b})) under an infinite-electrode condition.

$$T ( E ; {V}_{b} ) = T r [ ( G {Γ}_{E 1} {G}^{†} ) ( {Γ}_{E 1}^{†} G {Γ}_{E 2} ) ( G {Γ}_{E 2} {G}^{†} ) ( {Γ}_{E 1} {G}^{†} {Γ}_{E 2}^{†} ) ] \qquad 〈 Equation 17 〉$$

(where T(E; V_{b}) is a transmission function, Tr[x] is a trace function, Γ_{E1} is a broadening coupling matrix of the first electrode, G is the Green's function, Γ_{E2} is a broadening coupling matrix of the second electrode, and t denotes a Hermitian conjugate.)

Referring to Equation 17, the transmission function (T(E; V_{b})) may be derived through the trace function (Tr[x]), the broadening coupling matrix (Γ_{E1}) of the first electrode, the Green's function (G), and the broadening coupling matrix (Γ_{E2}) of the second electrode.

In Equation 17, the Green's function (G) derived under a condition in which the electrode unit EP is a finite electrode may be substituted. Equation 17 may be an equation for deriving the transmission function (T(E; V_{b})) under a finite-electrode condition.

$$I ( {V}_{b} ) = \frac{2 e}{h} {\int }_{{μ}_{E 1}}^{{μ}_{E 2}} T ( E ; {V}_{b} ) [ {f}_{E 2} - {f}_{E 1} ] d E \qquad 〈 Equation 18 〉$$

(where I(v_{b}) is a current value according to a voltage, e is an electron charge, h is a Planck constant, μ_{E1} is an electrochemical potential of the first electrode, μ_{E2} is an electrochemical potential of the second electrode, T(E; V_{b}) is a transmission function, f_{E2} is an occupation probability of the second electrode, and f_{E1} is an occupation probability of the first electrode.)

Referring to Equation 18, Equation 18 may be a Landauer formula. The electrochemical potential (μ_{E1}) of the first electrode and the electrochemical potential (μ_{E2}) of the second electrode may be the electrochemical potential (μ_{E1}) of the first electrode and the electrochemical potential (μ_{E2}) of the second electrode among a plurality of final electrochemical potentials (μ_{L}). Through the Landauer formula, the current value I (v_{b}) according to a voltage may be derived, and thus the voltage-current characteristic may be derived.

A partial polarization (P̅ₚ) may be defined as polarization of electrons distributed in apart of the device DV in a non-equilibrium state. The partial polarization (P̅ₚ) may include a channel polarization (P̅_{CH}). The channel polarization (P̅_{CH}) may be defined as polarization of electrons distributed in the channel CH. The channel CH may be a part of the device DV in the non-equilibrium state.

The partial polarization (P̅_{P}) may be a local value and may be expressed in the form of a function whose value varies according to position. Among the partial polarizations (P̅_{P}), a channel polarization (P̅_{CH}) may be derived through Equation 19 below.

$${\overline{P}}_{C H} ( x ) = \int ( {ρ}_{C H}^{V} ( x ) - {ρ}_{C H}^{0} ( x ) ) d x \qquad 〈 Equation 19 〉$$

(where P̅_{CH} is a channel polarization,

$${ρ}_{C H}^{V}$$

is a non-equilibrium channel electron density, and

$${ρ}_{C H}^{0}$$

is an equilibrium channel electron density.)

Equation 19 may be a modified equation for obtaining polarization. In an equation for obtaining polarization, a non-equilibrium channel electron density

$$( {ρ}_{C H}^{V} )$$

may be substituted instead of a non-equilibrium electron density, and an equilibrium channel electron density

$$( {ρ}_{C H}^{0} )$$

may be substituted instead of an equilibrium electron density, such that the channel polarization (P̅_{CH}) may be derived. The channel polarization (P̅_{CH}) may affect performance of a capacitor device DV. The channel polarization (P̅_{CH}) may be used to understand performance of the capacitor device DV.

A partial electric displacement (D̅_{P}) may be defined as an electric displacement of electrons distributed in a part of the device DV in a non-equilibrium state. The partial electric displacement (D̅_{P}) may include an electrode-unit electric displacement (D̅_{EP}). The electrode-unit electric displacement (D̅_{EP}) may be defined as an electric displacement of electrons distributed in the electrode unit EP. The electrode unit EP may be a part of the device DV in the non-equilibrium state.

The partial electric displacement (D̅_{P}) may be a local value and may be expressed in the form of a function whose value varies according to position. Among the partial electric displacements (D̅_{P}), the electrode-unit electric displacement (D̅_{EP}) may be derived through Equation 20 below.

$${\overline{D}}_{E P} ( x ) = - {ϵ}_{0} ∇ \int {dx}^{′} \frac{{ρ}_{E P}^{V} ( {x}^{′} )}{4 {πϵ}_{0} \vert x - {x}^{′} \vert} \qquad 〈 Equation 20 〉$$

(where D̅_{EP} is an electrode-unit electric displacement, ϵ₀ is a permittivity of vacuum, and

$${ρ}_{E P}^{V}$$

is a non-equilibrium electrode-unit electron density.)

Equation 20 may be a modified equation for obtaining electric displacement. In an equation for obtaining electric displacement, a non-equilibrium electrode-unit electron density

$$( {ρ}_{E P}^{V} )$$

may be substituted instead of an electron density, such that the electrode-unit electric displacement (D̅_{EP}) may be derived. The electrode-unit electric displacement (D̅_{EP}) may affect performance of the capacitor device DV. The electrode-unit electric displacement (D̅_{EP}) may be used to understand performance of the capacitor device DV.

A partial dielectric constant (ϵ_{rP}) may be a dielectric constant of a part of the device DV in a non-equilibrium state. The partial dielectric constant (ϵ_{rP}) may include a channel dielectric constant (ϵ_{rCH}). The channel dielectric constant (ϵ_{rCH}) may be a dielectric constant of the channel CH. The channel CH may be a part of the device DV in the non-equilibrium state.

The partial dielectric constant (ϵ_{rP}) may be a local value and may be expressed in the form of a function whose value varies according to position. When the channel CH is linear, among the partial dielectric constants (ϵ_{rP}), the channel dielectric constant (ϵ_{rCH}) may be derived through Equation 21 below.

$${ϵ}_{r C H} ( x ) = \frac{{\overline{D}}_{E P} ( x )}{{\overline{D}}_{E P} ( x ) - {\overline{P}}_{c H} ( x )} \qquad 〈 Equation 21 〉$$

(where ϵ_{rCH} is a channel dielectric constant, D̅_{EP} is an electrode-unit electric displacement, and P̅_{CH} is a channel polarization.)

Equation 21 may be a modified equation for obtaining a dielectric constant. In an equation for obtaining a dielectric constant, an electrode-unit electric displacement (D̅_{EP}) may be substituted instead of an electric displacement, and a channel polarization (P̅_{CH}) may be substituted instead of a polarization, such that the channel dielectric constant (ϵ_{rCH}) may be derived. The channel dielectric constant (ϵ_{rCH}) may affect performance of a capacitor device DV. The channel dielectric constant (ϵ_{rCH}) may be used to understand performance of the capacitor device DV.

A total capacitance (C_{T}) may be a capacitance of the device DV. A value of the total capacitance (C_{T}) may be determined by a total amount of charge accumulated in the electrode unit EP. The total capacitance (C_{T}) may be affected by a geometric capacitance (C_{g}) and a quantum capacitance (C_{q}).

The total capacitance (C_{T}) may be derived through Equation 22 below.

$${C}_{T} = A {e}^{2} \frac{d {ρ}_{E P}}{d e V} \qquad 〈 Equation 22 〉$$

(where C_{T} is a total capacitance, A is an area of the electrode unit, e is an electron charge, ρ_{EP} is an electrode-unit electron density, and V is a voltage applied to the electrode unit.)

Equation 22 may be a modified equation for obtaining capacitance. In an equation for obtaining capacitance, an electrode-unit electron density (ρ_{EP}) may be substituted instead of an electron density, such that the total capacitance (C_{T}) may be derived.

A geometric capacitance (C_{g}) may be a classical capacitance formed due to a shape of the device DV. A value of the geometric capacitance (C_{g}) may be determined by an amount of charge accumulated in the electrode unit EP due to the shape of the electrode unit EP.

The geometric capacitance (C_{g}) may be derived through Equations 23 and 24 below.

$$Δ φ = {φ}_{E 1} - {φ}_{E 2} \qquad 〈 Equation 23 〉$$

(where Δφ is an electric potential difference, φ_{E1} is a first electric potential, and φ_{E2} is a second electric potential.)

$${C}_{g} = A {e}^{2} \frac{d {ρ}_{E P}}{de Δ φ} \qquad 〈 Equation 24 〉$$

(where C_{g} is a geometric capacitance, A is an area of the electrode unit, e is an electron charge, ρ_{EP} is an electrode-unit electron density, and Δφ is an electric potential difference.)

Equation 23 may be an equation for obtaining an electric potential difference. Equation 24 may be a modified equation for obtaining a geometric capacitance. In an equation for obtaining a geometric capacitance, an electrode-unit electron density (ρ_{EP}) may be substituted instead of an electron density, such that the geometric capacitance (C_{g}) may be derived.

A quantum capacitance (C_{q}) may be a quantum capacitance generated due to miniaturization of the device DV. The quantum capacitance (C_{q}) may be determined by an amount of charge accumulated in the electrode unit EP due to miniaturization of the electrode unit EP.

The quantum capacitance (C_{q}) may be derived through Equations 25 and 26 below.

$$Δμ = e V - e Δφ \qquad 〈 Equatio n 25 〉$$

(where Δμ is an electrochemical potential difference, e is an electron charge, Vis a voltage applied to the electrode unit, and Δφ is an electric potential difference.)

$${C}_{q} = A {e}^{2} \frac{d {ρ}_{E P}}{d Δ μ} \qquad 〈 Equation 26 〉$$

(where C_{q} is a quantum capacitance, A is an area of the electrode unit, e is an electron charge, ρ_{EP} is an electrode-unit electron density, and Δμ is an electrochemical potential difference.)

Equation 25 may be an equation for obtaining an electrochemical potential difference. Equation 26 may be a modified equation for obtaining a quantum capacitance. In an equation for obtaining a quantum capacitance, an electrode-unit electron density (ρ_{EP}) may be substituted instead of an electron density, such that the quantum capacitance (C_{q}) may be derived.

A relationship among the total capacitance (C_{T}), the geometric capacitance (C_{g}), and the quantum capacitance (C_{q}) may be expressed through Equation 27 below.

$$\frac{1}{{C}_{T}} = \frac{1}{{C}_{g}} + \frac{1}{{C}_{q}} \qquad 〈 Equation 27 〉$$

(where C_{T} is a total capacitance, C_{g} is a geometric capacitance, and C_{q} is a quantum capacitance.)

Equation 27 may be a relational equation among the total capacitance, the geometric capacitance, and the quantum capacitance. Through Equation 27, the relationship among the total capacitance (C_{T}), the geometric capacitance (C_{g}), and the quantum capacitance (C_{q}) may be identified. The total capacitance (C_{T}), the geometric capacitance (C_{g}), and the quantum capacitance (C_{q}) may affect performance of a capacitor device DV. The total capacitance (C_{T}), the geometric capacitance (C_{g}), and the quantum capacitance (C_{q}) may be used to understand performance of the capacitor device DV.

A non-equilibrium adsorption energy

$$( Δ {F}_{C H}^{V} )$$

may be an energy gain when a channel CH is adsorbed on an electrode unit EP in the device DV in a non-equilibrium state. The non-equilibrium adsorption energy

$$( Δ {F}_{C H}^{V} )$$

may be a type of free energy. The non-equilibrium adsorption energy

$$( Δ {F}_{C H}^{V} )$$

may be defined as a sum of a non-equilibrium channel enthalpy change

$$( Δ {H}_{C H}^{V} )$$

and a non-equilibrium electrode-channel interaction

$$( {E}_{a d s}^{V} ) .$$

The non-equilibrium adsorption energy

$$( Δ {F}_{C H}^{V} )$$

may provide information for understanding semiconductor processes and information for understanding energy devices such as lithium batteries.

A non-equilibrium channel enthalpy change

$$( Δ {H}_{C H}^{V} )$$

may be defined as an enthalpy change of the channel CH when a voltage is applied to the device DV. The non-equilibrium channel enthalpy change

$$( Δ {H}_{C H}^{V} )$$

may be an enthalpy difference between a channel CH in a non-equilibrium state and a channel CH in an equilibrium state. The non-equilibrium channel enthalpy change

$$( Δ {H}_{C H}^{V} )$$

may be derived through Equation 28 below.

A non-equilibrium electrode-channel interaction

$$( {E}_{a d s}^{V} )$$

may be defined as an interaction between the electrode unit EP and the channel CH in the device DV in a non-equilibrium state. The non-equilibrium electrode-channel interaction

$$( {E}_{a d s}^{V} )$$

may be derived through Equation 29 below. The non-equilibrium adsorption energy

$$( Δ {F}_{C H}^{V} )$$

may be derived through Equation 30.

$$Δ {H}_{C H}^{V} = {H}_{C H}^{V} - {H}_{C H}^{0} = {E}_{C H}^{V} - {E}_{C H}^{0} - EF \cdot {\overline{P}}_{C H} \qquad 〈 Equation 28 〉$$

(where

$$Δ {H}_{C H}^{V}$$

is a non-equilibrium channel enthalpy change,

$${H}_{C H}^{V}$$

is a non-equilibrium channel enthalpy,

$${H}_{C H}^{0}$$

is an equilibrium channel enthalpy,

$${E}_{C H}^{V}$$

is a non-equilibrium channel energy,

$${E}_{C H}^{0}$$

is an equilibrium channel energy, EF is an electric field, and P̅_{CH} is a channel polarization.)

Through Equation 28, the non-equilibrium channel enthalpy change

$$( Δ {H}_{C H}^{V} )$$

may be derived. The non-equilibrium channel enthalpy

$$( {H}_{C H}^{V} )$$

may be an enthalpy of the channel CH in a non-equilibrium state. The equilibrium channel enthalpy

$$( {H}_{C H}^{0} )$$

may be an enthalpy of the channel CH in an equilibrium state.

The equilibrium channel energy

$$( {E}_{C H}^{0} )$$

may be derived through density functional theory. The electric field (EF) may be an electric field formed in the channel CH due to a voltage applied to the electrode unit EP. The channel polarization (P̅_{CH}) may be derived through Equation 19 described above. The non-equilibrium channel energy

$$( {E}_{C H}^{V} )$$

may be a total energy of the channel CH in the device DV in a non-equilibrium state. The non-equilibrium channel energy

$$( {E}_{C H}^{V} )$$

may be difficult to derive as an accurate value.

$${E}_{a d s}^{V} = {E}_{T}^{V} - {E}_{EP}^{V} - {E}_{CH}^{V} \qquad Equation 29$$

(where

$${E}_{a d s}^{V}$$

is a non-equilibrium electrode-channel interaction,

$${E}_{T}^{V}$$

is a non-equilibrium total energy,

$${E}_{E P}^{V}$$

is a non-equilibrium electrode-unit energy, and

$${E}_{C H}^{V}$$

is a non-equilibrium channel energy.)

Through Equation 29, the non-equilibrium electrode-channel interaction

$$( {E}_{a d s}^{V} )$$

may be derived. The non-equilibrium total energy

$$( {E}_{T}^{V} )$$

and the non-equilibrium electrode-unit energy

$$( {E}_{EP}^{V} )$$

may be derived through multi-space density functional theory. Meanwhile, the non-equilibrium channel energy

$$( {E}_{C H}^{V} )$$

may be difficult to derive as an accurate value.

$$Δ {F}_{CH}^{V} = Δ {H}_{CH}^{V} + {E}_{ads}^{V} = {E}_{T}^{V} - {E}_{E P}^{V} - {E}_{CH}^{0} - EF \cdot {\overline{P}}_{CH} \qquad Equation 30$$

(where

$$Δ {F}_{CH}^{V}$$

is a non-equilibrium adsorption energy,

$$Δ {H}_{CH}^{V}$$

is a non-equilibrium channel enthalpy change,

$${E}_{ads}^{V}$$

is a non-equilibrium electrode-channel interaction,

$${E}_{T}^{V}$$

is a non-equilibrium total energy,

$${E}_{EP}^{V}$$

is a non-equilibrium electrode-unit energy,

$${E}_{CH}^{0}$$

is an equilibrium channel energy, EF is an electric field, and P̅_{CH} is a channel polarization.)

Through Equation 30, the non-equilibrium adsorption energy

$$( Δ {F}_{C H}^{V} )$$

may be derived. The non-equilibrium channel energy

$$( {E}_{C H}^{V} )$$

may be eliminated in a process in which the non-equilibrium channel enthalpy change

$$( Δ {H}_{C H}^{V} )$$

and the non-equilibrium electrode-channel interaction

$$( {E}_{a d s}^{V} )$$

are added. Accordingly, a value of the non-equilibrium adsorption energy

$$( Δ {F}_{C H}^{V} )$$

may be derived without an accurate value of the non-equilibrium channel energy

$$( {E}_{C H}^{V} ) .$$

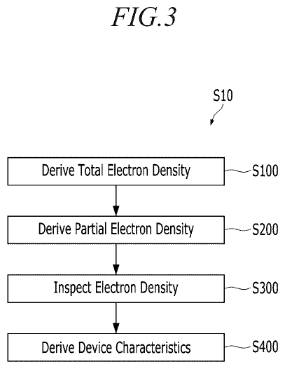

FIG. 3 is an example of a flowchart of a device analysis method S10 according to an embodiment of the present disclosure. Referring to FIG. 3, the device analysis method S10 may include a total analysis step S100, a separated analysis step S200, an electron-density comparison step S300, and a precision analysis step S400. In the device analysis method S10 of FIG. 3, the device DV of FIG. 1 may be analyzed through the device analysis system 1 of FIG. 2. The device DV may be analyzed through a first-principles methodology. As a result, the device DV may be simulated.

In the total analysis step S100, a total analysis on the device DV may be performed. In the total analysis step S100, the device DV may be simulated and characteristics of the device DV may be derived. For example, a total electron density (ρ_{T}) may be derived. A more detailed description of the total analysis step S100 may be provided with reference to separate drawings.

In the separated analysis step S200, a separated analysis on the device DV may be performed. In the separated analysis step S200, the device DV may be simulated and partial characteristics of the device DV may be derived. For example, a partial electron density (ρₚ) may be derived. A more detailed description of the separated analysis step S200 may be provided with reference to separate drawings. The separated analysis step S200 may be performed a plurality of times such that a plurality of partial electron densities (ρₚ) may be derived.

In the electron-density comparison step S300, a sum of the plurality of partial electron densities (ρₚ) and the total electron density (ρ_{T}) may be compared with each other. In the electron-density comparison step S300, when a difference between the total electron density (ρ_{T}) and the sum of the plurality of partial electron densities (ρₚ) is less than or equal to a reliability threshold value, the total electron density (ρ_{T}) and the plurality of partial electron densities (ρₚ) may be classified as high-reliability data. The high-reliability data may be used for training an artificial neural network.

In the electron-density comparison step S300, when the difference between the total electron density (ρ_{T}) and the sum of the plurality of partial electron densities (ρₚ) exceeds the reliability threshold value, at least one of the total analysis step S100 and the separated analysis step S200 may be performed again. Meanwhile, the electron-density comparison step S300 may be omitted.

In the precision analysis step S400, non-equilibrium characteristics, partial characteristics, and partial non-equilibrium characteristics of the device DV may be derived. For example, a voltage-current characteristic, a partial polarization (P̅_{P}), a partial electric displacement (D̅_{P}), a partial dielectric constant (ϵ_{rP}), a total capacitance (C_{T}), a geometric capacitance (C_{g}), a quantum capacitance (C_{q}), and a non-equilibrium adsorption energy

$$( Δ {F}_{C H}^{V} )$$

may be derived.

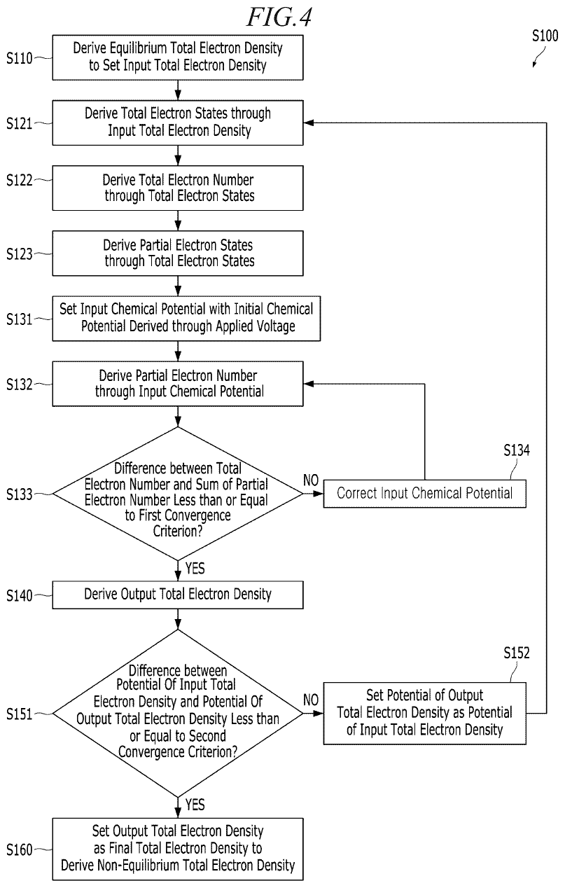

FIG. 4 is an example of a flowchart of the total analysis step S100 according to an embodiment of the present disclosure. Referring to FIG. 4, the total analysis step S100 may include a total electron density inputting step S110, a total electron state deriving step S121, a total electron number deriving step S122, a partial electron state deriving step S123, an electrochemical potential inputting step S131, a partial electron number deriving step S132, a first determination step S133, an electrochemical potential re-inputting step S134, a total electron density outputting step S140, a second determination step S151, a total electron density re-inputting step S152, and a total electron density deriving step S160.

In the total electron density inputting step S110, an initial total electron density (ρ_{TF}) may be set. In addition, the initial total electron density (ρ_{TF}) may be substituted into an input total electron density (ρ_{TI}), such that the input total electron density (ρ_{TI}) may be set.

In the total electron state deriving step S121, total electron states may be derived through the input total electron density (ρ_{T}). For example, an energy level (εᵢ) of each electron state and a wavefunction (ψᵢ) of each electron state may be derived. The total electron states may be derived through Equation 2 described above.

In the total electron number deriving step S122, a total electron number (N₀) may be derived through the total electron states. The total electron number may be derived through Equations 3 and 4 described above.

In the partial electron state deriving step S123, a plurality of partial electron states may be derived through the total electron states. The plurality of partial electron states may be defined by separating the total electron states based on position.

In the electrochemical potential inputting step S131, a plurality of initial electrochemical potentials (μ_{F}) may be set. In the electrochemical potential inputting step S131, a plurality of input electrochemical potentials (μᵢ) may be set through the plurality of initial electrochemical potentials (μ_{F}).

In the partial electron number deriving step S132, a plurality of partial electron numbers (N_{P}) may be derived through the plurality of input electrochemical potentials (μᵢ) and the plurality of partial electron states. The plurality of partial electron numbers (N_{P}) may be derived through Equations 3 and 4 described above.

In the first determination step S133, the total electron number (N₀) and a sum of the plurality of partial electron numbers (N_{P}) may be compared with each other. In the first determination step S133, when a difference between the total electron number (N₀) and the sum of the plurality of partial electron numbers (N_{P}) exceeds a first convergence criterion, the electrochemical potential re-inputting step S134 may be performed.

In the first determination step S133, when the difference between the total electron number (N₀) and the sum of the plurality of partial electron numbers (N_{P}) is less than or equal to the first convergence criterion, a plurality of output electrochemical potentials (μₒ) may be derived, and the total electron density outputting step S140 may be performed. The plurality of output electrochemical potentials (μₒ) derived in the first determination step S133 may be identical to the plurality of input electrochemical potentials (μᵢ).

In the first determination step S133, a progression method of the electrochemical potential re-inputting step S134 may be determined. In the electrochemical potential re-inputting step S134, a plurality of output electrochemical potentials (μₒ) may be derived. The plurality of output electrochemical potentials (μₒ) derived in the electrochemical potential re-inputting step S134 may be different from the plurality of input electrochemical potentials (μᵢ).

The plurality of output electrochemical potentials (μₒ) may vary according to a relationship between the total electron number (N₀) and the sum of the plurality of partial electron numbers (N_{P}).

When a value obtained by subtracting the sum of the plurality of partial electron numbers (N_{P}) from the total electron number (N₀) is greater than the first convergence criterion, in the step of re-inputting an electrochemical potential (S134), an output electrochemical potential (μ_{O1}) of a first electrode having a value obtained by adding a potential increment to an input electrochemical potential (μᵢ₁) of the first electrode, and an output electrochemical potential (μ_{O2}) of a second electrode having a value obtained by adding the potential increment to an input electrochemical potential (μᵢ₂) of the second electrode, may be derived. The plurality of output electrochemical potentials (μₒ) may be substituted into the plurality of input electrochemical potentials (μᵢ), such that the plurality of input electrochemical potentials (μᵢ) may be reset.

When a value obtained by subtracting the total electron number (N₀) from the sum of the plurality of partial electron numbers (N_{P}) is greater than the first convergence criterion, in the step of re-inputting an electrochemical potential (S134), an output electrochemical potential (μ_{O1}) of the first electrode having a value obtained by subtracting a potential decrement from the input electrochemical potential (μᵢ₁) of the first electrode, and an output electrochemical potential (μ_{O2}) of the second electrode having a value obtained by subtracting the potential decrement from the input electrochemical potential (μᵢ₂) of the second electrode, may be derived. The plurality of output electrochemical potentials (μₒ) may be substituted into the plurality of input electrochemical potentials (μᵢ), such that the plurality of input electrochemical potentials (μᵢ) may be reset.

In the total electron density outputting step S140, an occupation probability (fₜ) of each electron state may be derived through the plurality of output electrochemical potentials (μₒ). In the total electron density outputting step S140, an output total electron density (ρ_{TO}) may be derived through the occupation probability (fᵢ) of each electron state and the wavefunction (ψᵢ) of each electron state. The output total electron density (ρ_{TO}) may be derived through Equations 8 and 9 described above. In addition, in the total electron density outputting step S140, a potential of the output total electron density (ρ_{TO}) may be derived.

In the second determination step S151, it may be determined whether a difference between a potential of the input total electron density (ρ_{TI}) and a potential of the output total electron density (ρ_{TO}) is less than or equal to a second convergence criterion. In the second determination step S151, when the difference between the potential of the input total electron density (ρ_{TI}) and the potential of the output total electron density (ρ_{TO}) exceeds the second convergence criterion, the total electron density re-inputting step S152 may be performed. In the second determination step S151, when the difference between the potential of the input total electron density (ρ_{TI}) and the potential of the output total electron density (ρ_{TO}) is less than or equal to the second convergence criterion, the total electron density deriving step S160 may be performed.

In the total electron density re-inputting step S152, a value of the output total electron density (ρ_{TO}) may be substituted into the input total electron density (ρ_{TI}). Accordingly, the input total electron density (ρ_{TI}) may be reset.

In the total electron density deriving step S160, a total electron density (ρ_{T}) may be derived through the output total electron density (ρ_{TO}). In the total electron density deriving step S160, the output total electron density (ρ_{TO}) may be substituted into a final total electron density (ρ_{TL}). The total electron density (ρ_{T}) may be derived through the final total electron density (ρ_{TL}).

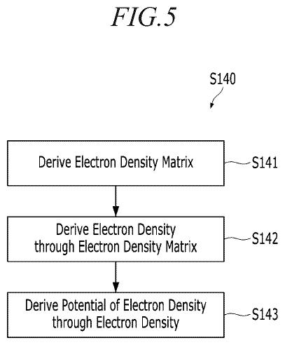

FIG. 5 is an example of a flowchart of the total electron density outputting step S140 according to an embodiment of the present disclosure. The total electron density outputting step S140 may include an electron density matrix deriving step S141, an electron density deriving step S142, and a total potential deriving step S143.

In the electron density matrix deriving step S141, an electron density matrix (D_{μv}) may be derived. The electron density matrix (D_{μv}) may be derived through Equation 8 described above.

In the electron density deriving step S142, an output total electron density (ρ_{TO}) may be derived. The output total electron density (ρ_{TO}) may be derived through an electron density (n(\vec{r})) at a spatial coordinate R derived through Equation 9 described above.

In the total potential deriving step S143, a potential of the output total electron density (ρ_{TO}) may be derived.

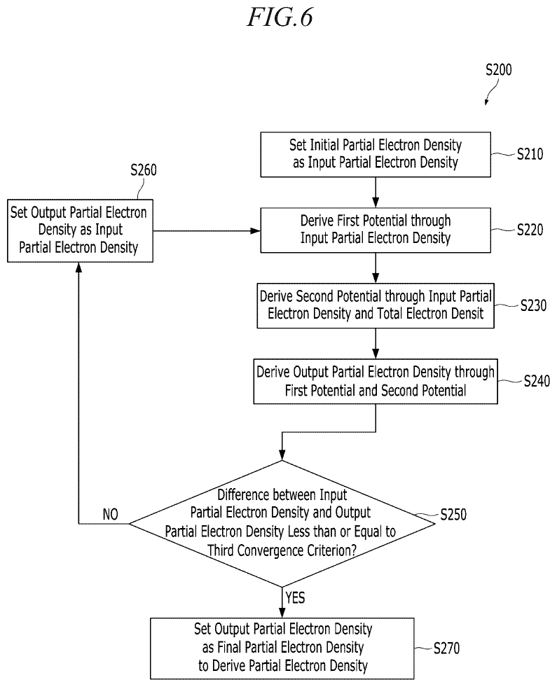

FIG. 6 is an example of a flowchart of the separated analysis step S200 according to an embodiment of the present disclosure. The separated analysis step S200 may include a partial electron density inputting step S210, a first potential deriving step S220, a second potential deriving step S230, a partial electron density outputting step S240, a third determination step S250, a partial electron density re-inputting step S260, and a partial electron density deriving step S270.

In the partial electron density inputting step S210, an initial partial electron density (ρ_{PF}) may be set. In addition, the initial partial electron density (ρ_{PF}) may be substituted into an input partial electron density (ρ_{PI}), such that the input partial electron density (ρ_{PI}) may be set.

In the first potential deriving step S220, a first potential (v₁) may be derived through the input partial electron density (ρ_{PI}). The first potential (v₁) may be derived through Equation 10 described above.

In the second potential deriving step S230, a second potential (v₂) may be derived through the input partial electron density (ρ_{PI}) and the total electron density (ρ_{T}). The second potential (v₂) may be derived through Equation 11 described above.

In the partial electron density outputting step S240, an output partial electron density (ρ_{PO}) may be derived through the first potential (v₁) and the second potential (v₂). The output partial electron density (ρ_{PO}) may be derived through Equations 12 and 13 described above.

In the third determination step S250, the input partial electron density (ρ_{PI}) and the output partial electron density (ρ_{PO}) may be compared with each other. When a difference between the input partial electron density (ρ_{PI}) and the output partial electron density (ρ_{PO}) exceeds a third convergence criterion, the partial electron density re-inputting step S260 may be performed. When the difference between the input partial electron density (ρ_{PI}) and the output partial electron density (ρ_{PO}) is less than or equal to the third convergence criterion, the partial electron density deriving step S270 may be performed.

In the partial electron density re-inputting step S260, the output partial electron density (ρ_{PO}) may be substituted into the input partial electron density (ρ_{PI}), such that the input partial electron density (ρ_{PI}) may be re-input. Thereafter, the first potential deriving step S220, the second potential deriving step S230, the partial electron density outputting step S240, and the third determination step S250 may be performed again through the re-input input partial electron density (ρ_{PI}). The partial electron density re-inputting step S260 may be repeatedly performed multiple times. In a process in which the partial electron density re-inputting step S260 is repeatedly performed, a difference between the input partial electron density (ρ_{PI}) and the output partial electron density (ρ_{PO}) may decrease. As a result, the input partial electron density (ρ_{PI}) and the output partial electron density (ρ_{PO}) may converge with each other, and the difference between the input partial electron density (ρ_{PI}) and the output partial electron density (ρ_{PO}) may become less than or equal to the third convergence criterion.

In the partial electron density deriving step S270, a partial electron density (ρₚ) may be derived through the output partial electron density (ρ_{PO}). In the partial electron density deriving step S270, the output partial electron density (ρ_{PO}) may be set as a final partial electron density (ρ_{PL}). The partial electron density (ρₚ) may be derived through the final partial electron density (ρ_{PL}).

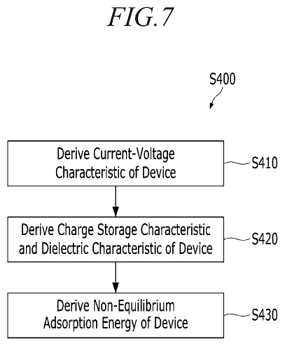

FIG. 7 is an example of a flowchart of the precision analysis step S400 according to an embodiment of the present disclosure. Referring to FIG. 7, the precision analysis step S400 may include a voltage-current characteristic deriving step S410, a charge storage and dielectric characteristic deriving step S420, and a non-equilibrium adsorption energy deriving step S430.

In the voltage-current characteristic deriving step S410, a voltage-current characteristic may be derived. The voltage-current characteristic may be determined through a Landauer formula.

In the charge storage and dielectric characteristic deriving step S420, a partial polarization (P̅ₚ), a partial electric displacement (D̅_{P}), a partial dielectric constant (ϵ_{rP}), and a partial capacitance (C_{P}) may be derived.

In the non-equilibrium adsorption energy deriving step S430, a non-equilibrium adsorption energy

$$( Δ {F}_{C H}^{V} )$$

may be derived.

Meanwhile, the configuration of the precision analysis step S400 is not limited to the flowchart described above. An order of the steps of the precision analysis step S400 may be changed, and a part of the precision analysis step S400 may be omitted.

FIG. 8 is an example of a flowchart of the voltage-current characteristic deriving step S410 according to an embodiment of the present disclosure. Referring to FIG. 8, the voltage-current characteristic deriving step S410 may include an analysis potential deriving step S411, an electrode determination step S412, a self-energy deriving step S413, a Green's function deriving step S414, a transmission function deriving step S415, and a current-voltage formula deriving step S416.

In the analysis potential deriving step S411, a potential of a total electron density (ρ_{T}) may be derived. The total electron density (ρ_{T}) may be a non-equilibrium total electron density

$$( {ρ}_{T}^{V} ) .$$

In the electrode determination step S412, it may be determined whether an electrode unit EP of the device DV is an infinite electrode or a finite electrode.

The self-energy deriving step S413 may include an infinite-electrode self-energy deriving step S4131 and a finite-electrode self-energy deriving step S4132. In the self-energy deriving step S413, a self-energy matrix (Σ) may be derived. When the electrode unit EP is an infinite electrode, the infinite-electrode self-energy deriving step S4131 may be performed to derive the self-energy matrix (Σ). When the electrode unit EP is a finite electrode, the finite-electrode self-energy deriving step S4132 may be performed to derive the self-energy matrix (Σ).

In the infinite-electrode self-energy deriving step S4131, a surface Green's function (gₛ) may be derived through density functional theory or a non-equilibrium Green's function. The surface Green's function (gₛ) may be substituted into Equation 14 described above to derive the self-energy matrix (Σ).

In the finite-electrode self-energy deriving step S4132, after a non-equilibrium total electron density

$$( {ρ}_{T}^{V} )$$

is substituted into a Kohn-Sham Hamiltonian matrix (H[x]), a surface Green's function (gₛ) may be derived through data corresponding to an electrode portion of the Kohn-Sham Hamiltonian matrix (H[x]). The surface Green's function (gₛ) may be substituted into Equation 14 described above to derive the self-energy matrix (Σ).

The Green's function deriving step S414 may include an infinite-electrode Green's function deriving step S4141 and a finite-electrode Green's function deriving step S4142. In the Green's function deriving step S414, a Green's function (G) may be derived. When the electrode unit EP is an infinite electrode, the infinite-electrode Green's function deriving step S4141 may be performed to derive the Green's function (G). When the electrode unit EP is a finite electrode, the finite-electrode Green's function deriving step S4142 may be performed to derive the Green's function (G).

In the infinite-electrode Green's function deriving step S4141, the self-energy matrix (Σ) derived in the infinite-electrode self-energy deriving step S4131 may be substituted into Equation 15 described above to derive the Green's function (G).

In the finite-electrode Green's function deriving step S4142, the self-energy matrix (Σ) derived in the finite-electrode self-energy deriving step S4132 may be substituted into Equation 15 described above to derive the Green's function (G).

The transmission function deriving step S415 may include an infinite-electrode transmission function deriving step S4151 and a finite-electrode transmission function deriving step S4152. In the transmission function deriving step S415, a transmission function (T(E; V_{b})) may be derived. When the electrode unit EP is an infinite electrode, the infinite-electrode transmission function deriving step S4151 may be performed to derive the transmission function (T(E; V_{b})). When the electrode unit EP is a finite electrode, the finite-electrode transmission function deriving step S4152 may be performed to derive the transmission function (T(E; V_{b})).

In the infinite-electrode transmission function deriving step S4151, the Green's function (G) derived in the infinite-electrode Green's function deriving step S4141 may be substituted into Equation 16 described above to derive the transmission function (T(E; V_{b})).

In the finite-electrode transmission function deriving step S4152, the Green's function (G) derived in the finite-electrode Green's function deriving step S4142 may be substituted into Equation 17 described above to derive the transmission function (T(E; V_{b})).

In the current-voltage formula deriving step S416, the transmission function (T(E; V_{b})) derived in the transmission function deriving step S415 may be substituted into Equation 18 described above to derive a Landauer formula. Through the Landauer formula, a voltage-current characteristic may be derived.

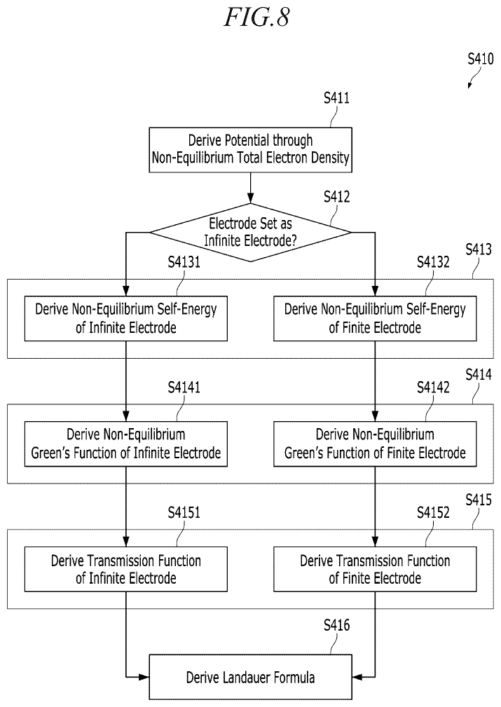

FIG. 9 is an example of a flowchart of the charge storage and dielectric characteristic deriving step S420 according to an embodiment of the present disclosure. Referring to FIG. 9, the charge storage and dielectric characteristic deriving step S420 may include a polarization deriving step S421, an electric displacement deriving step S422, a dielectric constant deriving step S423, and a capacitance deriving step S424.

In the polarization deriving step S421, a partial polarization (P̅ₚ) may be derived. The partial polarization (P̅ₚ) may be derived through Equation 19 described above.

In the electric displacement deriving step S422, a partial electric displacement (D̅_{P}) may be derived. The partial electric displacement (D̅ₚ) may be derived through Equation 20 described above.

In the dielectric constant deriving step S423, a partial dielectric constant (ϵ_{rP}) may be derived. The partial dielectric constant (ϵ_{rP}) may be derived through Equation 21 described above.

In the capacitance deriving step S424, a total capacitance (C_{T}), a geometric capacitance (C_{g}), and a quantum capacitance (C_{q}) may be derived. As described above, the total capacitance (C_{T}) may be derived through Equation 22. The geometric capacitance (C_{g}) may be derived through Equations 23 and 24. In addition, the quantum capacitance (C_{q}) may be derived through Equations 25 and 26.

Meanwhile, the configuration of the charge storage and dielectric characteristic deriving step S420 is not limited to the flowchart described above. An order of the steps of the charge storage and dielectric characteristic deriving step S420 may be changed, and a part of the charge storage and dielectric characteristic deriving step S420 may be omitted.

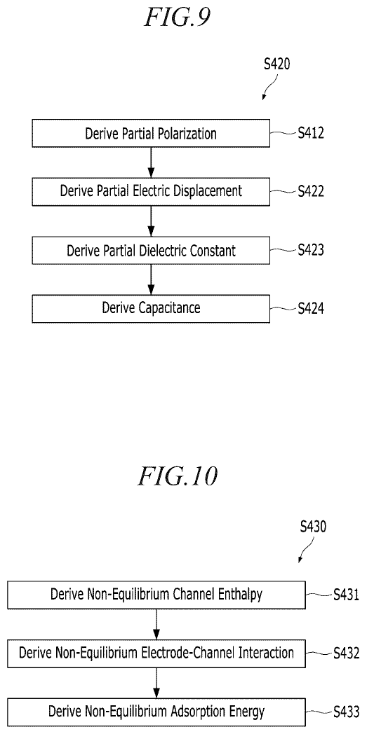

FIG. 10 is an example of a flowchart of the non-equilibrium adsorption energy deriving step S430 according to an embodiment of the present disclosure. Referring to FIG. 10, the non-equilibrium adsorption energy deriving step S430 may include a non-equilibrium channel enthalpy change deriving step S431, a non-equilibrium electrode-channel interaction deriving step S432, and a non-equilibrium adsorption energy calculating step S433.

In the non-equilibrium channel enthalpy change deriving step S431, a non-equilibrium channel enthalpy change

$$( Δ {H}_{C H}^{V} )$$

may be derived. The non-equilibrium channel enthalpy change

$$( Δ {H}_{C H}^{V} )$$

may be derived through Equation 28 described above.

In the non-equilibrium electrode-channel interaction deriving step S432, a non-equilibrium electrode-channel interaction

$$( {E}_{a d s}^{V} )$$

may be derived. The non-equilibrium electrode-channel interaction

$$( {E}_{a d s}^{V} )$$

may be derived through Equation 29 described above.

In the non-equilibrium adsorption energy calculating step S433, a non-equilibrium adsorption energy

$$( Δ {F}_{C H}^{V} )$$

may be calculated and derived. The non-equilibrium adsorption energy

$$( Δ {F}_{C H}^{V} )$$

may be calculated through Equation 30 described above.

Hereinafter, experimental examples using the device analysis system 1 of the present disclosure will be described.

### Experimental Example 1

In Experimental Example 1 of the present disclosure, a device DV was simulated through the device analysis system 1. The simulated device DV was analyzed through the device analysis system 1. The device DV included an electrode unit EP including a first electrode E1 and a second electrode E2, and a channel CH disposed between the first electrode E1 and the second electrode E2. The first electrode E1 and the second electrode E2 were set as gold electrodes having infinite thickness, and the channel CH was set as boron nitride having a layered structure parallel to the first electrode E1 and the second electrode E2.

In Experimental Example 1, an inverse of a channel dielectric constant

$$( \frac{1}{{ϵ}_{r C H}} )$$

according to position and an inverse of a total dielectric constant

$$( \frac{1}{{ϵ}_{r T}} )$$

were compared. The total dielectric constant was defined as a dielectric constant of the device DV. In addition, a capacitance according to an applied voltage was derived.

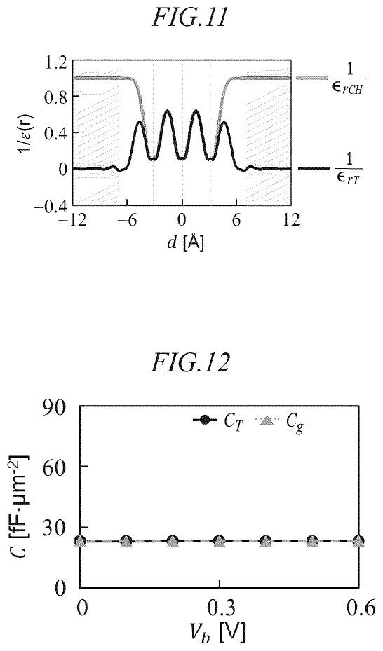

FIG. 11 is a graph illustrating, according to Experimental Example 1 of the present disclosure, an inverse of a channel dielectric constant

$$( \frac{1}{{ϵ}_{r C H}} )$$

according to position and an inverse of a total dielectric constant

$$( \frac{1}{{ϵ}_{r T}} ) .$$

Referring to FIG. 11, it may be confirmed that, in a central portion in which the channel CH is located, an influence of the channel CH is large, such that the inverse of the channel dielectric constant

$$( \frac{1}{{ϵ}_{r C H}} )$$

and the inverse of the total dielectric constant

$$( \frac{1}{{ϵ}_{r T}} )$$

are substantially identical to each other. In contrast, at both end portions in which the electrode unit EP is located, the influence of the channel CH decreases, such that the inverse of the channel dielectric constant

$$( \frac{1}{{ϵ}_{rCH}} )$$

and the inverse of the total dielectric constant

$$( \frac{1}{{ϵ}_{r T}} )$$

are different from each other. Accordingly, through Experimental Example 1, it may be confirmed that characteristics of the channel CH are separated in the device DV.

FIG. 12 is a graph illustrating capacitance according to an applied voltage, according to Experimental Example 1 of the present disclosure. Referring to FIG. 12, the first electrode E1 and the second electrode E2 are set as gold electrodes having infinite thickness, such that an influence of quantum effects may be small. Accordingly, in FIG. 12, it may be confirmed that the geometric capacitance (C_{g}) has a large influence on the total capacitance (C_{T}), whereas the quantum capacitance (C_{q}) does not have a significant influence.

### Experimental Example 2

In Experimental Example 2 of the present disclosure, a device DV was simulated through the device analysis system 1. The simulated device DV was analyzed through the device analysis system 1. The device DV included an electrode unit EP including a first electrode E1 and a second electrode E2, and a channel CH disposed between the first electrode E1 and the second electrode E2. The first electrode E1 and the second electrode E2 were set as graphene electrodes having finite thickness, and the channel CH was set as boron nitride having a layered structure parallel to the first electrode E1 and the second electrode E2.

In Experimental Example 2, an inverse of a channel dielectric constant

$$( \frac{1}{{ϵ}_{r C H}} )$$

according to position and an inverse of a total dielectric constant

$$( \frac{1}{{ϵ}_{r T}} )$$

were compared. In addition, a capacitance according to an applied voltage was derived.

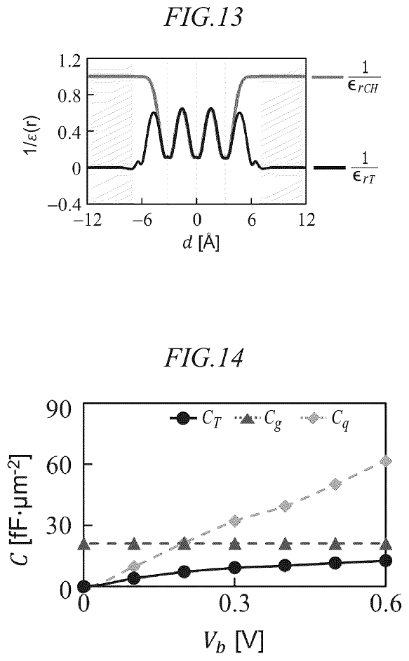

FIG. 13 is a graph illustrating, according to Experimental Example 2 of the present disclosure, an inverse of a channel dielectric constant

$$( \frac{1}{{ϵ}_{r C H}} )$$

according to position and an inverse of a total dielectric constant

$$( \frac{1}{{ϵ}_{r T}} ) .$$

Referring to FIG. 13, even when thicknesses of the first electrode E1 and the second electrode E2 are finite as in Experimental Example 2, it may be confirmed that characteristics of the channel CH are separated in the device DV.

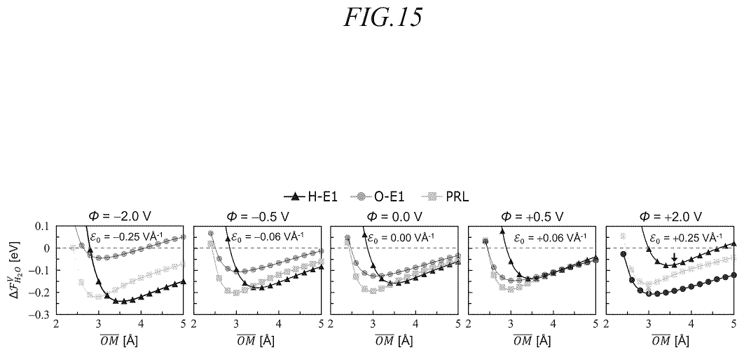

FIG. 14 is a graph illustrating capacitance according to an applied voltage, according to Experimental Example 2 of the present disclosure. Referring to FIG. 14, the first electrode E1 and the second electrode E2 are set as graphene electrodes having finite thickness, such that an influence of quantum effects may be large. Accordingly, in FIG. 14, it may be confirmed that the total capacitance (C_{T}) is affected by the geometric capacitance (C_{g}) and the quantum capacitance (C_{q}).

### Experimental Example 3

In Experimental Example 3 of the present disclosure, a device DV was simulated through the device analysis system 1. The simulated device DV was analyzed through the device analysis system 1. The device DV included an electrode unit EP including a first electrode E1 and a second electrode E2, and a channel CH disposed between the first electrode E1 and the second electrode E2. The first electrode E1 and the second electrode E2 were set as gold electrodes having infinite thickness, and the channel CH was set as water.

In Experimental Example 3, a non-equilibrium adsorption energy

$$( Δ {F}_{C H}^{V} )$$

was derived according to an electric potential (φ), a distance from the first electrode E1, and an orientation of water molecules constituting the channel CH.

FIG. 15 is a set of graphs illustrating, according to Experimental Example 3 of the present disclosure, anon-equilibrium adsorption energy

$$( Δ {F}_{C H}^{V} )$$

of water molecules according to an electric potential (φ) and a distance from the first electrode E1. Referring to FIG. 15, water molecules constituting the channel CH may have, depending on orientation, a hydrogen-adjacent state H-E1, an oxygen-adjacent state O-E1, or a parallel state PRL. In each of the plurality of graphs of FIG. 15, a vertical axis represents the non-equilibrium adsorption energy

$$( Δ {F}_{C H}^{V} )$$

of a water molecule, and a horizontal axis represents a distance from the first electrode E1.

A water molecule in the hydrogen-adjacent state H-E1 may be a water molecule in which hydrogen in the water molecule faces the first electrode E1. A water molecule in the oxygen-adjacent state O-E1 may be a water molecule in which oxygen in the water molecule faces the first electrode E1. A water molecule in the parallel state PRL may be a water molecule oriented parallel to the first electrode E1.

When the electric potential (φ) is −2.0 V or less, it was confirmed that the non-equilibrium adsorption energy

$$( Δ {F}_{C H}^{V} )$$

of the water molecule in the hydrogen-adjacent state H-E1 is the smallest. Accordingly, when the electric potential (φ) is −2.0 V or less, it was confirmed that hydrogen of the water molecule faces the first electrode E1.

When the electric potential (φ) is −0.5 V or greater and 0.5 V or less, it was confirmed that the non-equilibrium adsorption energy

$$( Δ {F}_{C H}^{V} )$$

of the water molecule in the parallel state PRL is the smallest. Accordingly, when the electric potential (φ) is −0.5 V or greater and 0.5 V or less, it was confirmed that the water molecule is oriented parallel to the first electrode E1.

When the electric potential (φ) is 2.0 V or greater, it was confirmed that the non-equilibrium adsorption energy

$$( Δ {F}_{C H}^{V} )$$

of the water molecule in the oxygen-adjacent state O-E1 is the smallest. Accordingly, when the electric potential (φ) is 2.0 V or greater, it was confirmed that oxygen of the water molecule faces the first electrode E1.

As a result, by deriving the non-equilibrium adsorption energy

$$( Δ {F}_{C H}^{V} ) ,$$

an orientation of molecules constituting the channel CH may be identified.

### Experimental Example 4

In Experimental Example 4 of the present disclosure, a device DV was simulated through the device analysis system 1. The simulated device DV was analyzed through the device analysis system 1. The device DV included an electrode unit EP including a first electrode E1 and a second electrode E2, and a channel CH disposed between the first electrode E1 and the second electrode E2. The first electrode E1 was set as a graphene electrode having finite thickness, the second electrode E2 was set as a gold electrode having infinite thickness, and the channel CH was set as water.

In Experimental Example 4, a non-equilibrium adsorption energy

$$( Δ {F}_{C H}^{V} )$$

was derived according to an electric potential (φ), a distance from the first electrode E1, and an orientation of water molecules constituting the channel CH.

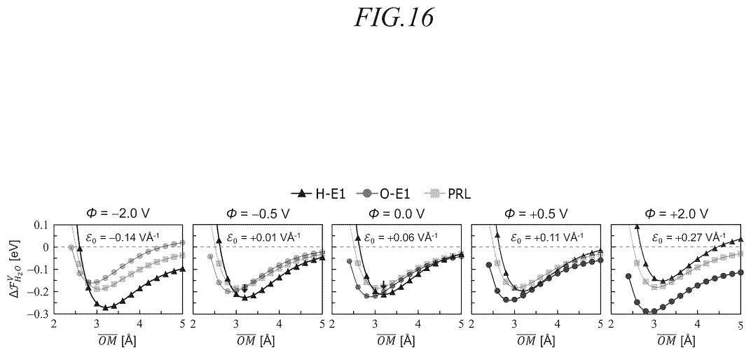

FIG. 16 is a graph illustrating, according to Experimental Example 4 of the present disclosure, a non-equilibrium adsorption energy

$$( Δ {F}_{C H}^{V} )$$

of water molecules according to an electric potential (φ) and a distance from the first electrode E1. Referring to FIG. 16, water molecules constituting the channel CH may have, depending on orientation, a hydrogen-adjacent state H-E1, an oxygen-adjacent state O-E1, or a parallel state PRL. In each of the plurality of graphs of FIG. 16, a vertical axis represents the non-equilibrium adsorption energy

$$( Δ {F}_{C H}^{V} )$$

of a water molecule, and a horizontal axis represents a distance from the first electrode E1.

When the electric potential (φ) is −0.5 V or less, it was confirmed that the non-equilibrium adsorption energy

$$( Δ {F}_{C H}^{V} )$$

of the water molecule in the hydrogen-adjacent state H-E1 is the smallest. Accordingly, when the electric potential (φ) is −0.5 V or less, it was confirmed that hydrogen of the water molecule faces the first electrode E1.

When the electric potential (φ) is 0 V, it was confirmed that the non-equilibrium adsorption energy

$$( Δ {F}_{C H}^{V} )$$

of the water molecule in the hydrogen-adjacent state H-E1 and the non-equilibrium adsorption energy

$$( Δ {F}_{C H}^{V} )$$

of the water molecule in the oxygen-adjacent state O-E1 are similar to each other, and that the non-equilibrium adsorption energy

$$( Δ {F}_{C H}^{V} )$$

of the water molecule in the parallel state PRL is relatively high. Accordingly, when the electric potential (φ) is 0 V, it was confirmed that hydrogen of some water molecules faces the first electrode E1 and oxygen of other water molecules faces the first electrode E1.

When the electric potential (φ) is 0.5 V or greater, it was confirmed that the non-equilibrium adsorption energy

$$( Δ {F}_{C H}^{V} )$$

of the water molecule in the oxygen-adjacent state O-E1 is the smallest. Accordingly, when the electric potential (φ) is 0.5 V or greater, it was confirmed that oxygen of the water molecule faces the first electrode E1.

As a result, by deriving the non-equilibrium adsorption energy

$$( Δ {F}_{C H}^{V} ) ,$$

an orientation of molecules constituting the channel CH may be identified. In addition, by comparing results of Experimental Example 3 and Experimental Example 4, it may be confirmed that behavior of molecules constituting the channel CH varies depending on a configuration of the electrode unit EP.

Although the present disclosure has been described with reference to the embodiments, those skilled in the art to which the present disclosure pertains will understand that various modifications and changes may be made to the present disclosure without departing from the spirit and scope of the present disclosure as set forth in the appended claims. In addition, the embodiments disclosed herein are not intended to limit the technical idea of the present disclosure, and all technical ideas within the scope of the appended claims and equivalents thereof should be construed as being included in the scope of the present disclosure.

What is claimed is:

1. A device analysis system comprising a controller configured to simulate a device including an electrode unit and a channel, wherein the device is a device in a non-equilibrium state in which a voltage is applied to the electrode unit, and wherein the controller is configured to derive a total electron density defined as a probability density of electrons distributed in the device,
wherein the controller is configured to derive a total electron number defined as a number of electrons constituting the device through total electron states corresponding to states of electrons constituting the device,
wherein the controller is configured to derive a plurality of partial electron numbers, each defined as a number of electrons constituting a part of the device, through a plurality of input electrochemical potentials and a plurality of partial electron states,
wherein the controller is configured to compare a sum of the plurality of partial electron numbers with the total electron number and derive a plurality of output electrochemical potentials through the plurality of input electrochemical potentials, and
wherein the controller is configured to derive an occupation probability of each electron state through the plurality of output electrochemical potentials and derive the total electron density through the occupation probability of each electron state.

2. The device analysis system of claim 1, wherein the electrode unit comprises a first electrode and a second electrode, and
wherein the channel is disposed between the first electrode and the second electrode.

3. The device analysis system of claim 2, wherein the plurality of input electrochemical potentials comprise an input electrochemical potential of the first electrode and an input electrochemical potential of the second electrode,
wherein the plurality of output electrochemical potentials comprise an output electrochemical potential of the first electrode and an output electrochemical potential of the second electrode,
wherein the controller is configured to, when a value obtained by subtracting a sum of the plurality of partial electron numbers from the total electron number is greater than a first convergence criterion, derive an output electrochemical potential of the first electrode having a value obtained by adding a potential increment to the input electrochemical potential of the first electrode and an output electrochemical potential of the second electrode having a value obtained by adding the potential increment to the input electrochemical potential of the second electrode, and substitute the plurality of output electrochemical potentials into the plurality of input electrochemical potentials to reset the plurality of input electrochemical potentials,
wherein the controller is configured to, when the value obtained by subtracting the sum of the plurality of partial electron numbers from the total electron number is less than the first convergence criterion, derive an output electrochemical potential of the first electrode having a value obtained by subtracting a potential decrement from the input electrochemical potential of the first electrode and an output electrochemical potential of the second electrode having a value obtained by subtracting the potential decrement from the input electrochemical potential of the second electrode, and substitute the plurality of output electrochemical potentials into the plurality of input electrochemical potentials to reset the plurality of input electrochemical potentials,
wherein the controller is configured to re-derive the plurality of partial electron numbers through the reset plurality of input electrochemical potentials, and
wherein the controller is configured to, when a difference between the sum of the plurality of partial electron numbers and the total electron number is less than or equal to the first convergence criterion, derive the plurality of output electrochemical potentials identical to the plurality of input electrochemical potentials.

4. The device analysis system of claim 3, wherein the controller is configured to derive an initial electrochemical potential through a voltage applied to the electrode unit, and set the initial electrochemical potential as the input electrochemical potential.

5. The device analysis system of claim 4, wherein the controller is configured to derive the total electron states through an input total electron density,
wherein the controller is configured to derive an output total electron density through an occupation probability of each electron state,
wherein the controller is configured to, when a difference between a potential of the input total electron density and a potential of the output total electron density exceeds a second convergence criterion, reset the input total electron density as the output total electron density and re-derive the total electron states through the reset input total electron density, and
wherein the controller is configured to, when the difference between the potential of the input total electron density and the potential of the output total electron density is less than or equal to the second convergence criterion, derive the total electron density through the output total electron density.

6. The device analysis system of claim 5, wherein the controller is configured to perform analysis on the device to derive a partial electron density including at least one of an electrode-unit electron density defined as a probability density of electrons distributed in the electrode unit or a channel electron density defined as a probability density of electrons distributed in the channel,
wherein the controller is configured to derive a first potential through an input partial electron density,
wherein the controller is configured to derive a second potential through the input partial electron density and the total electron density, and
wherein the controller is configured to derive an output partial electron density through the first potential and the second potential.

7. The device analysis system of claim 6, wherein the controller is configured to, when a difference between the input partial electron density and the output partial electron density is less than or equal to a third convergence criterion, derive the partial electron density through the output partial electron density, and
wherein the controller is configured to, when the difference between the input partial electron density and the output partial electron density exceeds the third convergence criterion, substitute the output partial electron density into the input partial electron density, re-derive the first potential through the input partial electron density, re-derive the second potential through the input partial electron density and the total electron density, and re-derive the output partial electron density through the first potential and the second potential.

8. The device analysis system of claim 7, wherein the first potential is an effective potential of the input partial electron density according to density functional theory, and
wherein the second potential is a value obtained by subtracting a Hartree potential of the input partial electron density from a Hartree potential of the total electron density according to density functional theory.

9. The device analysis system of claim 8, wherein the controller is configured to derive an initial partial electron density through the total electron density, and set the initial partial electron density as the input partial electron density.

10. The device analysis system of claim 9, wherein the controller is configured to derive a plurality of partial electron densities,
wherein the controller is configured to compare a sum of the plurality of partial electron densities with the total electron density, and
wherein the controller is configured to, when a difference between the sum of the plurality of partial electron densities and the total electron density is less than or equal to a reliability criterion, classify the sum of the plurality of partial electron densities and the total electron density as high-reliability data.

11. The device analysis system of claim 10, wherein the controller is configured to, when the difference between the sum of the plurality of partial electron densities and the total electron density exceeds the reliability criterion, re-derive at least one of the total electron density or the plurality of partial electron densities.

12. The device analysis system of claim 6, wherein the controller is configured to derive a self-energy matrix of the device through the total electron density,
wherein the controller is configured to derive a Green's function through the self-energy matrix,
wherein the controller is configured to derive a transmission function through the Green's function, and
wherein the controller is configured to derive a Landauer formula through the transmission function.

13. A device analysis method comprising:
performing a total analysis in which a device including an electrode unit having a first electrode and a second electrode and a channel disposed between the first electrode and the second electrode is simulated, wherein the device is a device in a non-equilibrium state in which a voltage is applied to the electrode unit, and analysis is performed on the device to derive a total electron density defined as a probability density of electrons distributed in the device,
wherein the step of performing a total analysis comprises:
deriving a total electron number in which a total electron number defined as a number of electrons constituting the device is derived through total electron states corresponding to states of electrons constituting the device;
deriving a partial electron number in which a plurality of partial electron numbers, each defined as a number of electrons constituting a part of the device, are derived through a plurality of input electrochemical potentials and a plurality of partial electron states;
re-inputting an electrochemical potential in which a sum of the plurality of partial electron numbers and the total electron number are compared with each other and a plurality of output electrochemical potentials are derived through the plurality of input electrochemical potentials; and
outputting a total electron density in which an occupation probability of each electron state is derived through the plurality of output electrochemical potentials and an output total electron density is derived through the occupation probability of each electron state.

14. The device analysis method of claim 13, wherein the plurality of input electrochemical potentials comprise an input electrochemical potential of the first electrode and an input electrochemical potential of the second electrode,
wherein the plurality of output electrochemical potentials comprise an output electrochemical potential of the first electrode and an output electrochemical potential of the second electrode,
wherein the step of performing a total analysis further comprises a first determination step in which a progression method of the step of re-inputting an electrochemical potential is determined,
wherein, in the first determination step, when a value obtained by subtracting a sum of the plurality of partial electron numbers from the total electron number is greater than a first convergence criterion, an output electrochemical potential of the first electrode having a value obtained by adding a potential increment to the input electrochemical potential of the first electrode and an output electrochemical potential of the second electrode having a value obtained by adding the potential increment to the input electrochemical potential of the second electrode are derived in the step of re-inputting an electrochemical potential,
wherein, in the first determination step, when a value obtained by subtracting the total electron number from the sum of the plurality of partial electron numbers is greater than the first convergence criterion, an output electrochemical potential of the first electrode having a value obtained by subtracting a potential decrement from the input electrochemical potential of the first electrode and an output electrochemical potential of the second electrode having a value obtained by subtracting the potential decrement from the input electrochemical potential of the second electrode are derived in the step of re-inputting an electrochemical potential, and
wherein, in the first determination step, when a difference between the total electron number and the sum of the plurality of partial electron numbers is less than or equal to the first convergence criterion, the plurality of output electrochemical potentials identical to the plurality of input electrochemical potentials are derived.

15. The device analysis method of claim 14, wherein the step of performing a total analysis further comprises:
an output total electron density deriving step in which an output total electron density is derived through the plurality of input electrochemical potentials;
a total electron density re-inputting step in which the output total electron density is substituted into an input total electron density; and
a second determination step in which, when a difference between a potential of the input total electron density and a potential of the output total electron density is less than or equal to a second convergence criterion, the output total electron density deriving step is performed, and when the difference between the potential of the input total electron density and the potential of the output total electron density exceeds the second convergence criterion, the total electron density re-inputting step is performed,
wherein, when the total electron density re-inputting step is performed, the step of deriving a total electron number, the step of deriving a partial electron number, the first determination step, the step of re-inputting an electrochemical potential, and the output total electron density deriving step are re-performed.

16. The device analysis method of claim 15, further comprising a separated analysis step in which the device is simulated and analysis on the device is performed to derive a partial electron density including at least one of an electrode-unit electron density defined as a probability density of electrons distributed in the electrode unit or a channel electron density defined as a probability density of electrons distributed in the channel,
wherein the separated analysis step comprises:
a first potential deriving step in which a first potential is derived through an input partial electron density;
a second potential deriving step in which a second potential is derived through the input partial electron density and the total electron density; and
a partial electron density outputting step in which an output partial electron density is derived through the first potential and the second potential.

17. The device analysis method of claim 16, wherein the separated analysis step further comprises:
a partial electron density deriving step in which the partial electron density is derived through the output partial electron density;
a partial electron density re-inputting step in which the output partial electron density is substituted into the input partial electron density; and
a determination step in which, when a difference between the input partial electron density and the output partial electron density is less than or equal to a third convergence criterion, the partial electron density deriving step is performed, and when the difference between the input partial electron density and the output partial electron density exceeds the third convergence criterion, the partial electron density re-inputting step is performed,
wherein, when the partial electron density re-inputting step is performed, the first potential deriving step, the second potential deriving step, and the partial electron density outputting step are re-performed.

18. The device analysis method of claim 17, wherein, in the first potential deriving step, the first potential is derived as a value obtained by substituting the input partial electron density into a first functional,
wherein the first functional is a functional in which an electron density is substituted to derive an effective potential according to density functional theory,
wherein, in the second potential deriving step, the second potential is derived as a value obtained by subtracting a value obtained by substituting the input partial electron density into a second functional from a value obtained by substituting the total electron density into the second functional, and
wherein the second functional is a functional in which an electron density is substituted to derive a Hartree potential according to the density functional theory.

19. The device analysis method of claim 18, wherein the separated analysis step further comprises a partial electron density inputting step in which the input partial electron density is derived through the total electron density.

20. The device analysis method of claim 18, further comprising a current-voltage characteristic deriving step in which a current-voltage characteristic of the device is derived,
wherein the current-voltage characteristic deriving step comprises:
a self-energy deriving step in which a self-energy matrix of the device is derived through the total electron density;
a Green's function deriving step in which a Green's function is derived through the self-energy matrix;
a transmission function deriving step in which a transmission function is derived through the Green's function; and
a current-voltage formula deriving step in which a Landauer formula is derived through the transmission function.
